(19) United States
(12) Patent Application Publication
(10) Pub. No.: US 2024/0359362 A1
(43) Pub. Date: Oct. 31, 2024

(54) CONCRETE SAW

(71) Applicant: Black & Decker Inc., New Britain, CT (US)

(72) Inventors: Austin L. Ganzermiller, Reisterstown, MD (US); Matthew J. Lazzaro, Forest Hill, MD (US)

(21) Appl. No.: 18/647,676

(22) Filed: Apr. 26, 2024

Related U.S. Application Data
(60) Provisional application No. 63/498,443, filed on Apr. 26, 2023.

(51) Int. Cl. B28D 1/04; B23D 59/02

(52) U.S. Cl. CPC B28D 1/045; B23D 59/02

(57) ABSTRACT

A power-driven tool is provided. The tool is driven by a driving system including a multi-motor drive unit including multiple motors providing torque to a master gear of a transmission. Some of the motors are directly engaged with the master gear, and some of the motors are engaged with the master gear via an idler gear. The master gear drives a pulley assembly that, in turn, drives a blade of the power driven tool.

### CROSS REFERENCE TO RELATED APPLICATION

This application claims priority to and the benefit of U.S. Provisional Application No. 63/498,443, filed on Apr. 26, 2023, and titled “Multi-Motor Drive System,” which is hereby incorporated by reference in its entirety.

### FIELD

This relates to a power-driven cutting tool, and in particular to a concrete saw.

### BACKGROUND

Concrete saws can be used to cut or abrade numerous different types of workpieces at a work site. In particular, a concrete saw can be used to cut or abrade relatively hard materials, such as, for example, concrete, stone, masonry, brick, asphalt, tile, and other types of solid materials. Typically, concrete saws include a motor that generates a driving force, for example, a rotary force or torque, that is transmitted to a blade, causing the blade to rotate to perform a cutting or abrading operation on a workpiece. Concrete saws may make use of different types of blades, depending on characteristics of the material to be cut or abraded, characteristics of the operation to be performed on the workpiece, and the like, including, for example, hardness of the material, length and/or depth of a cut to be made, and the like. In some situation, concrete saws may perform wet cutting, to provide for lubrication and cooling of the blade during a cutting or abrading operation. Many concrete saws include powerful, somewhat large, motors in order to output the torque required to cut or abrade the types of solid materials typically encountered by concrete saws. In some situations, this may make the concrete saw heavy and/or difficult for the user to maintain stable operation and/or unwieldy in some work environments.

### SUMMARY

In some aspects, the techniques described herein relate to a power-driven tool, including: a housing; a driving system configured to transmit a driving force to a blade coupled to a first longitudinal end portion of the housing, the driving system including: a multi-motor drive unit, the multi-motor drive unit including a plurality of motors; a pulley assembly coupled to the blade; and a transmission coupled between the multi-motor drive unit and the pulley assembly and configured to transmit a driving force generated by the multi-motor drive unit to the pulley assembly to rotate the blade, wherein a planar arrangement of the multi-motor drive unit and the pulley assembly, and a planar arrangement of the transmission are positioned adjacent to and arranged in parallel with a central longitudinal plane defined by the blade.

In some aspects, the techniques described herein relate to a power-driven tool, wherein the multi-motor drive unit includes at least one motor of the plurality of motors directly engaged with a master gear of the transmission, and at least one motor of the plurality of motors engaged with the master gear via an idler gear.

In some aspects, the techniques described herein relate to a power-driven tool, wherein the multi-motor drive unit includes: a motor adapter; and a plurality of openings formed in the motor adapter, wherein each of the plurality of motors is received in a corresponding opening of the plurality of openings formed in the motor adapter, wherein the pulley assembly is received in an opening of the plurality of openings formed in the motor adapter.

In some aspects, the techniques described herein relate to a power-driven tool, further including a motor cover extending across a side portion of the motor adapter corresponding to the plurality of motors and defining a corresponding portion of the housing, wherein the motor cover includes a plurality of pads extending inward, from an interior surface of the motor cover toward the motor adapter, wherein the plurality of pads contact corresponding bearing surfaces of the motor adapter to maintain axial positions of the plurality of motors in the motor adapter.

In some aspects, the techniques described herein relate to a power-driven tool, wherein the transmission is positioned at a lateral side of the motor adapter, the transmission including: a master gear mounted on a driving shaft such that the master gear rotates together with the driving shaft; a first idler gear engaged with the master gear; and a second idler gear engaged with the master gear, wherein: a pinion of a first motor of the plurality of motors is engaged with the first idler gear, a pinion of a second motor of the plurality of motors is engaged with the second idler gear, and pinions of remaining motors of the plurality of motors are engaged with the master gear.

In some aspects, the techniques described herein relate to a power-driven tool, further including a transmission cover extending across a side portion of the motor adapter corresponding to the transmission and defining a corresponding portion of the housing, wherein the transmission cover includes a plurality of recesses in which the first idler gear, the second idler gear and the master gear are received, and a plurality of pads extending inward, from an interior surface of the transmission cover toward the transmission, wherein the plurality of recesses and the plurality of pads maintain relative positions of the first idler gear, the second idler gear and the master gear.

In some aspects, the techniques described herein relate to a power-driven tool, wherein the first motor and the second motor output a rotational force in a first rotational direction, and the remaining motors output a rotational force in a second rotational direction opposite the first rotational direction.

In some aspects, the techniques described herein relate to a power-driven tool, wherein inertial forces generated in response to operation of the first motor and the second motor of the plurality of motors are opposite inertial forces generated in response to operation of the remaining motors of the plurality of motors, such that the inertial forces generated in response to operation of the remaining motors of the plurality of motors cancel the inertial forces generated in response to operation of the first motor and the second motor of the plurality of motors.

In some aspects, the techniques described herein relate to a power-driven tool, wherein: axes of rotation of the plurality of motors are arranged in parallel to each other; axes of rotation of the first idler gear, the second idler gear and the master gear are arranged in parallel to each other; and an axis of rotation of the blade is arranged in parallel to the axes of rotation of the plurality of motors and the axes of rotation of the first idler gear, the second idler gear and the master gear.

In some aspects, the techniques described herein relate to a power-driven tool, wherein the pulley assembly includes: a first pulley mounted on the driving shaft such that the first pulley rotates together with the driving shaft and the master gear; a second pulley mounted on an output shaft such that the output shaft rotates together with the second pulley; and a belt mounted on the first pulley and the second pulley such that the second pulley and the output shaft rotate in response to rotation of the first pulley, wherein a hub assembly is mounted on the output shaft, and couples the blade to the output shaft such that the blade rotates in response to rotation of the second pulley and the output shaft.

In some aspects, the techniques described herein relate to a power-driven tool, wherein: axes of rotation of the first pulley, the second pulley, and the output shaft are arranged in parallel to each other, and in parallel with axes of rotation of the plurality of motors, and with axes of rotation of the first idler gear, the second idler gear and the master gear, and with an axis of rotation of the blade.

In some aspects, the techniques described herein relate to a power-driven tool, wherein: the plurality of motors of the multi-motor drive unit and the first pulley, the second pulley and the belt of the pulley assembly are arranged in a shared plane defined by the motor adapter; and the first idler gear, the second idler gear and the master gear are arranged in a shared plane, laterally adjacent to the motor adapter, between the motor adapter and the blade.

In some aspects, the techniques described herein relate to a power-driven tool, further including: a battery receptacle defined at a central portion of the housing and configured to removably receive a battery therein; a first handle portion at a second longitudinal end portion of the housing, opposite the first longitudinal end portion; and a second handle portion at an upper central portion of the housing, longitudinally positioned between the battery receptacle and the blade.

In some aspects, the techniques described herein relate to a power-driven tool, wherein the first handle portion and the second handle portion are aligned along the central longitudinal plane of the power-driven tool defined by the blade, with a center of gravity of the power-driven tool aligned along the central longitudinal plane.

In some aspects, the techniques described herein relate to a power-driven tool, wherein the multi-motor drive unit is positioned between the second handle portion and the blade, and the battery received in the battery receptacle is positioned adjacent to the multi-motor drive unit, below the second handle portion.

In some aspects, the techniques described herein relate to a power-driven tool, wherein, in an at rest position of the power-driven tool in which the battery is received in the battery receptacle, a center of gravity of the power-driven tool is positioned longitudinally forward of the second handle portion, and below the second handle portion, with a bottom surface of the housing positioned resting on a work surface with the blade spaced apart from the work surface.

In some aspects, the techniques described herein relate to a power-driven tool, wherein, in an at rest position of the power-driven tool in which the battery is not received in the battery receptacle, a center of gravity of the power-driven tool is positioned longitudinally forward of the second handle portion, and below the second handle portion, with a bottom surface of the housing positioned resting on a work surface with the blade spaced apart from the work surface.

In some aspects, the techniques described herein relate to a power-driven tool, wherein, in an operational position of the power-driven tool, in which the power-driven tool is rotated about a heel portion of the housing supported on a work surface, a center of gravity of the power-driven tool is positioned longitudinally forward of the heel portion and is aligned with a cut into the work surface defined by a diameter of the blade.

In some aspects, the techniques described herein relate to a power-driven tool, further including a cooling flow path extending through the power-driven tool, wherein cooling air is drawn into the housing through an inlet at an upper central portion of the housing at an upper end portion of the battery receptacle proximate the first handle portion, through the plurality of motors of the multi-motor drive unit, into a discharge chamber in the housing adjacent to a side portion of the battery receptacle, and is discharged through at least one discharge port at a base portion of the battery receptacle.

In some aspects, the techniques described herein relate to a power-driven tool, wherein cooling air is drawn from the inlet into a chamber defined between the housing and a first side of a motor adapter in which the plurality of motors are received, and through the plurality of motors and the motor adapter in response to operation of the plurality of motors, and is discharged from the motor adapter to the discharge chamber through a plurality of discharge channels defined in a second side of the motor adapter and respectively extending from the plurality of motors towards the discharge chamber.

In some aspects, the techniques described herein relate to a power-driven tool, wherein a power to volume ratio is in a range of approximately 2.0 W/cm3 to approximately 2.25 W/cm3.

In some aspects, the techniques described herein relate to a power-driven tool, wherein a power to mass ratio is in a range of approximately 920 W/kg to approximately 1000 W/kg.

### BRIEF DESCRIPTION OF THE DRAWINGS

FIG. 1 is a perspective view of an example concrete saw, from a first side of the example concrete saw.

FIG. 2 is a side view of the example concrete saw, from the first side of the example concrete saw.

FIG. 3 is a perspective view of the example concrete saw, from a second side of the example concrete saw.

FIG. 4 is a top view of the example concrete saw shown in FIGS. 1-3.

FIG. 5A is perspective view, and FIG. 5B is a side view, of the example concrete saw shown in FIGS. 1-4, from the first side of the example concrete saw, with a motor cover removed so that components of a motor drive unit of the example concrete saw are visible.

FIG. 5C is a perspective view of the example concrete saw shown in FIGS. 1-4, with the motor cover removed, so that an internal configuration of the motor cover is visible.

FIG. 6A is perspective view, and FIG. 6B is a side view, of the example concrete saw shown in FIGS. 1-4, from the second side of the example concrete saw, with a transmission cover removed so that components of a transmission of the example concrete saw are visible.

FIG. 6C is a perspective view of the example concrete saw shown in FIGS. 1-4, with the transmission cover removed, so that an internal configuration of the transmission cover is visible.

FIG. 7A is an exploded view of the example concrete saw shown in FIGS. 1-6C.

FIG. 7B is an exploded view of the example concrete saw, illustrating a flow of air through the example concrete saw.

FIG. 8 is a close in assembled view of a multi-motor drive unit including a plurality of motors and a pulley assembly, from a first side of the multi-motor drive unit.

FIG. 9 is a partially exploded view of the multi-motor drive unit shown in FIG. 8.

FIG. 10 is a partially exploded view of the multi-motor drive unit shown in FIG. 8.

FIG. 11 is a close in view of the multi-motor drive unit shown in FIGS. 8-10, from a second side of the multi-motor drive unit.

FIG. 12 is a close-in assembled view of a transmission engaged with the multi-motor drive unit shown in FIGS. 8-11.

FIG. 13 is a close-in view of an arrangement of motors, pulleys, and a master gear of the multi-motor drive unit and transmission.

FIG. 14 is a partially exploded view of the transmission shown in FIG. 12.

FIG. 15 is a first partially exploded view, and FIG. 16 is a second partially exploded view, of a driving system including the multi-motor drive unit, the transmission 600, and the pulley assembly shown in FIGS. 8-13.

FIG. 17 is an exploded view of a hub assembly.

FIG. 18A is a front view, and FIG. 18B is a partial side view, of the example concrete saw, illustrating example cut distances associated with operation of the example concrete saw.

FIG. 19A is a top view of the example concrete saw, illustrating alignment of a center of gravity of the example concrete saw with a blade of the example concrete saw.

FIG. 19B is a side view of the example concrete saw in an at rest position, illustrating a center of gravity of the example concrete saw, with a battery pack installed in a battery receptacle of the example concrete saw.

FIG. 19C is a side view of the example concrete saw in the at rest position, illustrating a center of gravity of the example concrete saw with the battery pack removed from the battery receptacle.

FIG. 19D is a side view of the example concrete saw in an operational position, illustrating a center of gravity of the example concrete saw during operation, with the battery pack installed in the battery receptacle.

FIG. 20 is a top view of the example concrete saw, illustrating axes of operation of rotating components of the example concrete saw.

FIG. 21 is a table, providing metrics associated with one example configuration of an example concrete saw.

### DETAILED DESCRIPTION

Concrete saws may be used to cut or abrade workpieces made of relatively hard, solid materials such as, for example, concrete, stone, masonry, brick, asphalt, tile, and the like. Due to the nature of the materials to be cut and/or abraded, concrete saws rely on a driving system including, for example a motor and transmission, providing a relatively high output force, or output torque, to drive or rotate a blade that performs a cutting or abrading operation on a workpiece. In some situations, accommodating the driving system having the desired output characteristics may result in a concrete saw configuration that can be relatively heavy and/or become difficult for a user to maintain balance and stability during operation. In some situations, accommodating the driving system having the desired output characteristics may adversely impact a form factor, and resulting lateral cut clearances, of the concrete saw. In some situations, accommodating the driving system having the desired output characteristics may impact the form factor, making ambidextrous operation of the concrete saw difficult.

A concrete saw including a driving system, in accordance with implementations described herein, may include a multi-motor drive unit including a plurality of motors. In some examples, the plurality of motors is engaged with a single gear of a transmission, the transmission transmitting an output force, generated by the plurality of motors, to a blade of the concrete saw, to rotate the blade. In some examples, a pulley assembly is operably coupled between the transmission and the blade, to transmit the output force from the transmission to the blade, to provide for rotation of the blade.

In some examples, axes of rotation of the plurality of motors are arranged in parallel with each other. In some examples, axes of rotation of one or more gears of the transmission are arranged in parallel with the axes of rotation of the plurality of motors. In some examples, axes of rotation of one or more pulleys of the pulley assembly are arranged in parallel with the axes of rotation of the gears of the transmission, and the axes of rotation of the plurality of motors. In some examples, the axis of rotation of the blade is arranged in parallel with the axes of rotation of the one or more pulleys of the pulley assembly, the axes of rotation of the gears of the transmission, and the axes of rotation of the plurality of motors. The parallel axis arrangement of the plurality of motors, gears of the transmission, pulleys of the pulley assembly, and the blade may provide for more stable operation of the concrete saw, and may reduce vibratory and/or inertial forces experienced by the user during operation of the concrete saw.

In some examples, the transmission may be positioned laterally adjacent to the plurality of motors and the pulley assembly, providing a driving system having a relatively small profile. The relatively smaller profile of the arrangement of the plurality of motors, transmission and pulley assembly, may allow for placement of a power source, such as, for example, a battery, at a more forward position with respect to the blade. In some examples, with a power source, such as a battery installed adjacent to the driving system, a center of gravity of the concrete saw may be at a central portion of the driving system arranged in this manner, allowing the center of gravity to fall into, or be in alignment with, a cut being made by the concrete saw. In some examples, this arrangement may cause the center of gravity to be aligned with, for example, longitudinally aligned with, the blade. In some examples, this allows a notable portion of the weight of the concrete saw to be directed into the cut, and not borne by the user during operation. This may improve lateral stability/balance of the concrete saw during operation, may enhance user operation and control of the concrete saw, and may reduce user fatigue associated with use of the concrete saw.

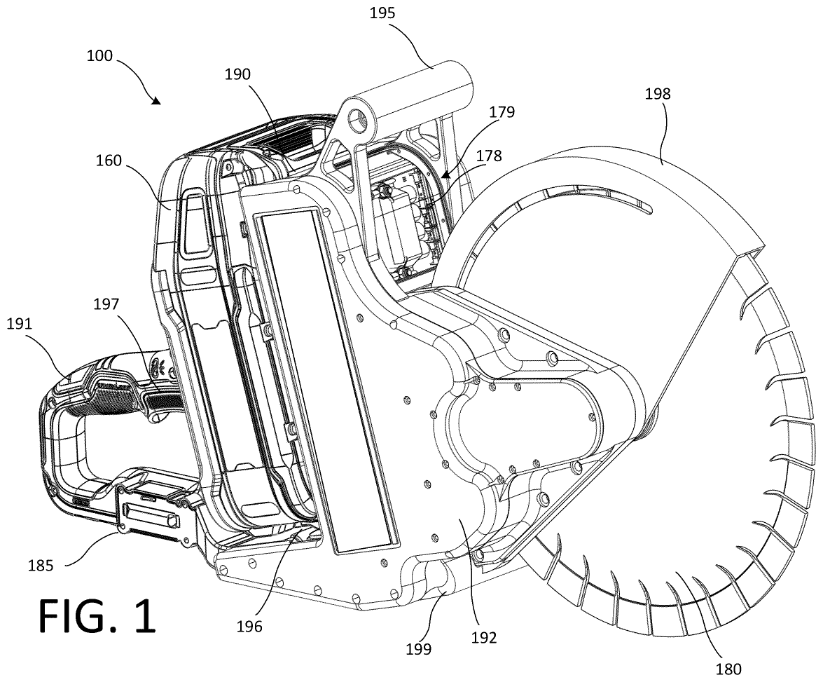

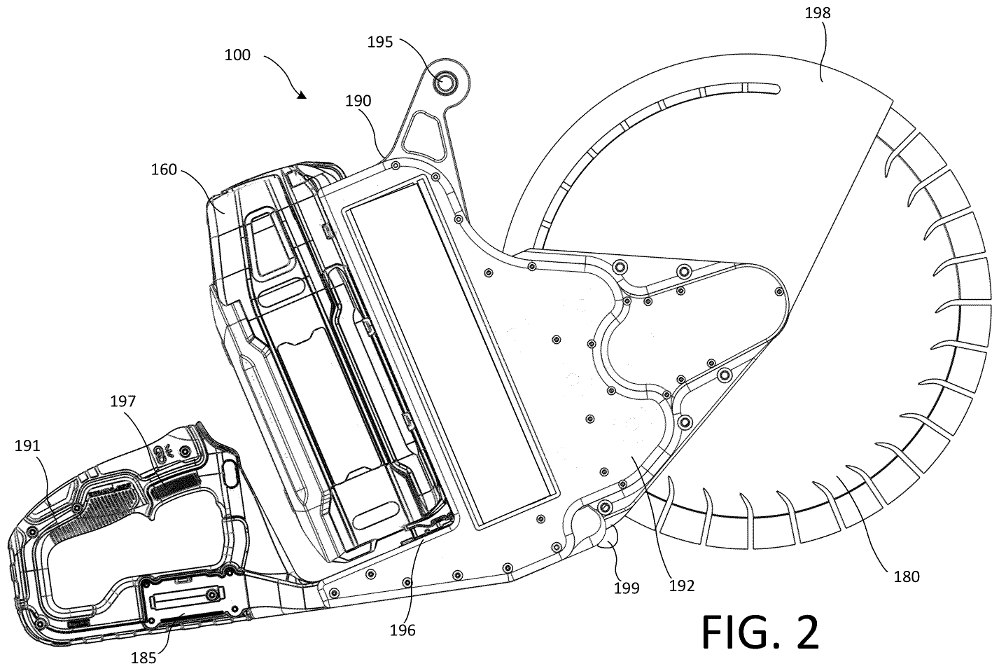

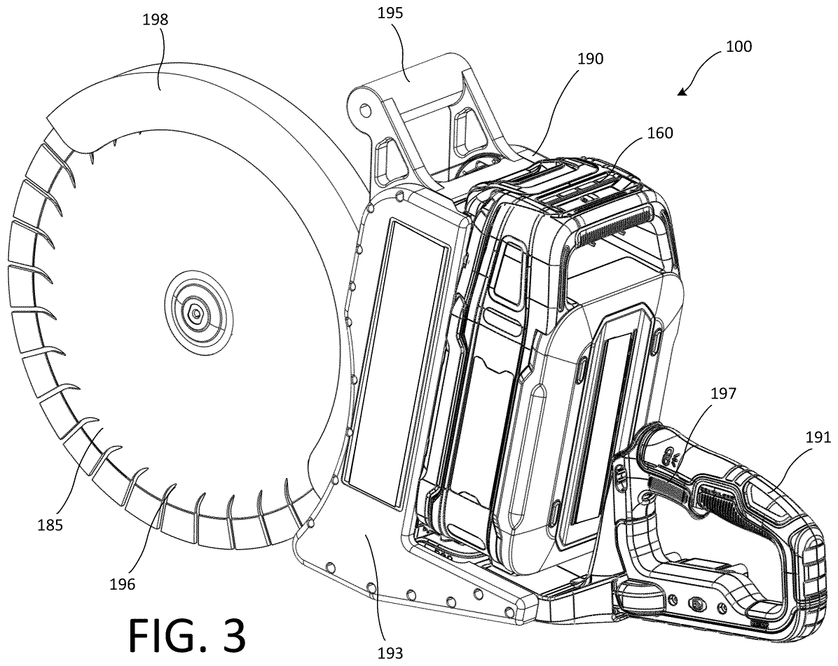

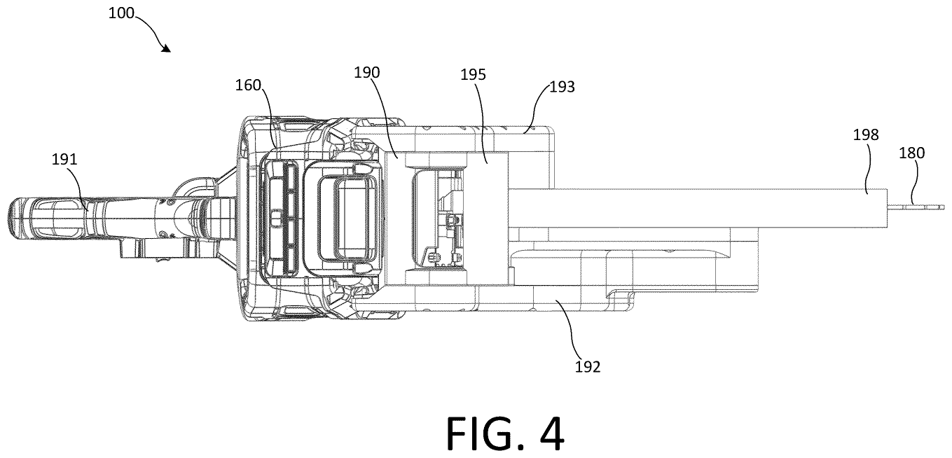

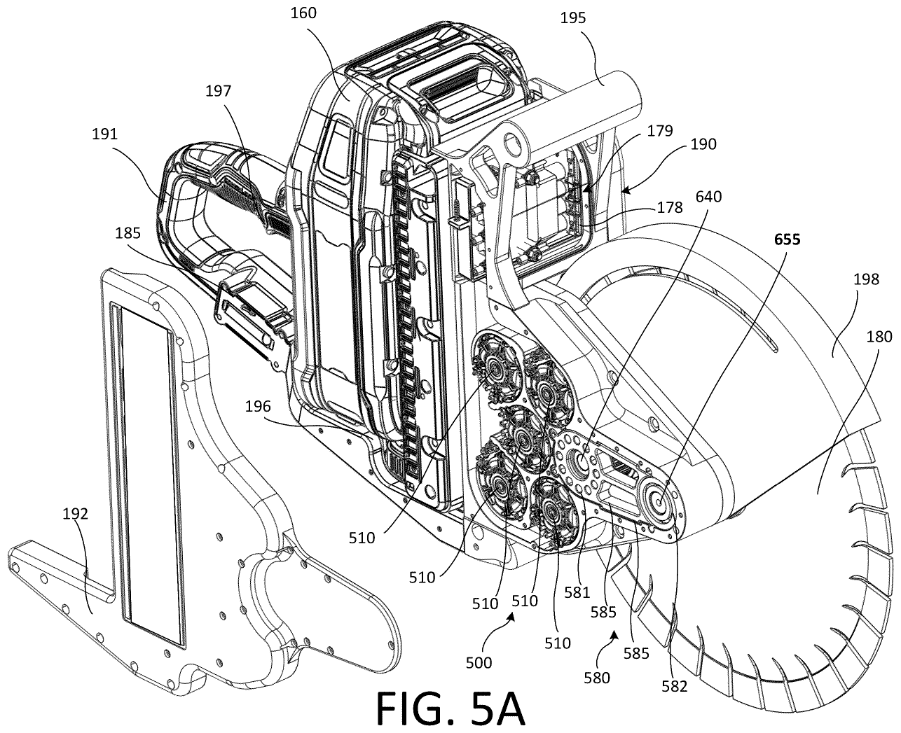

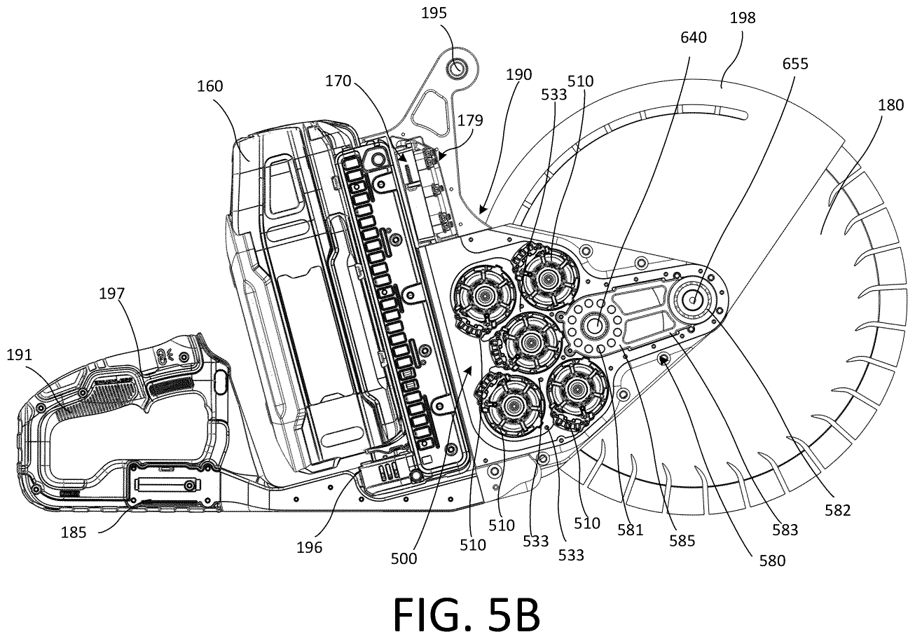

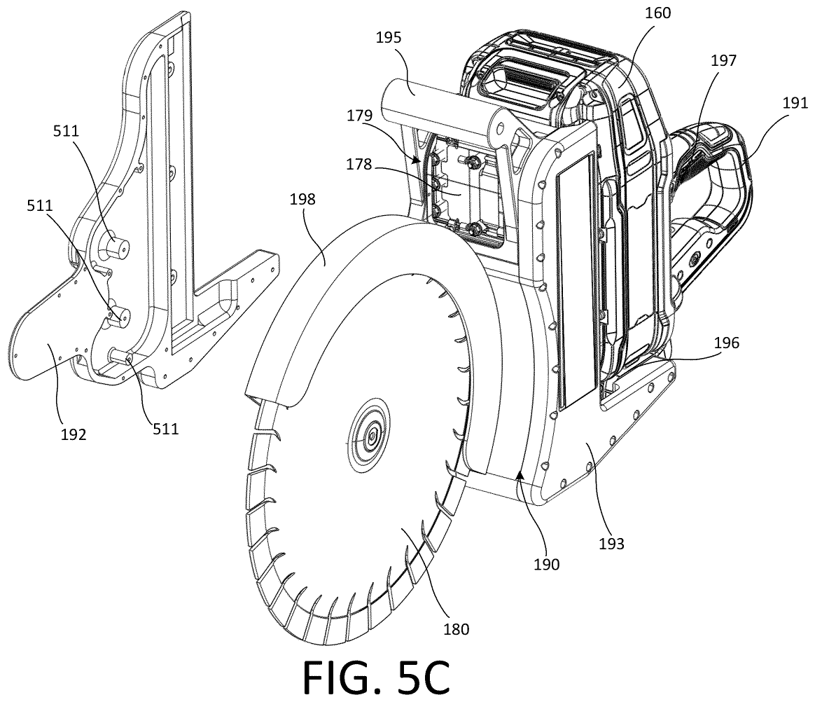

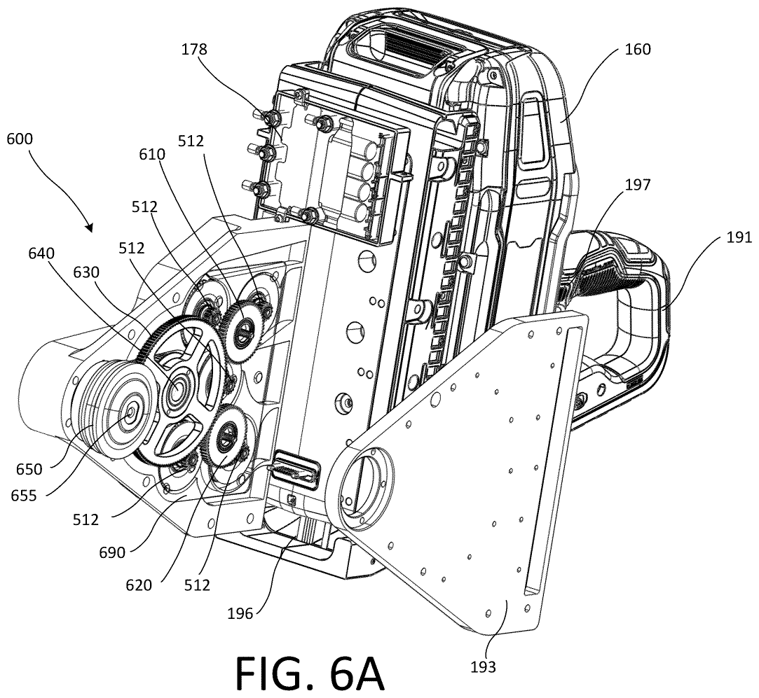

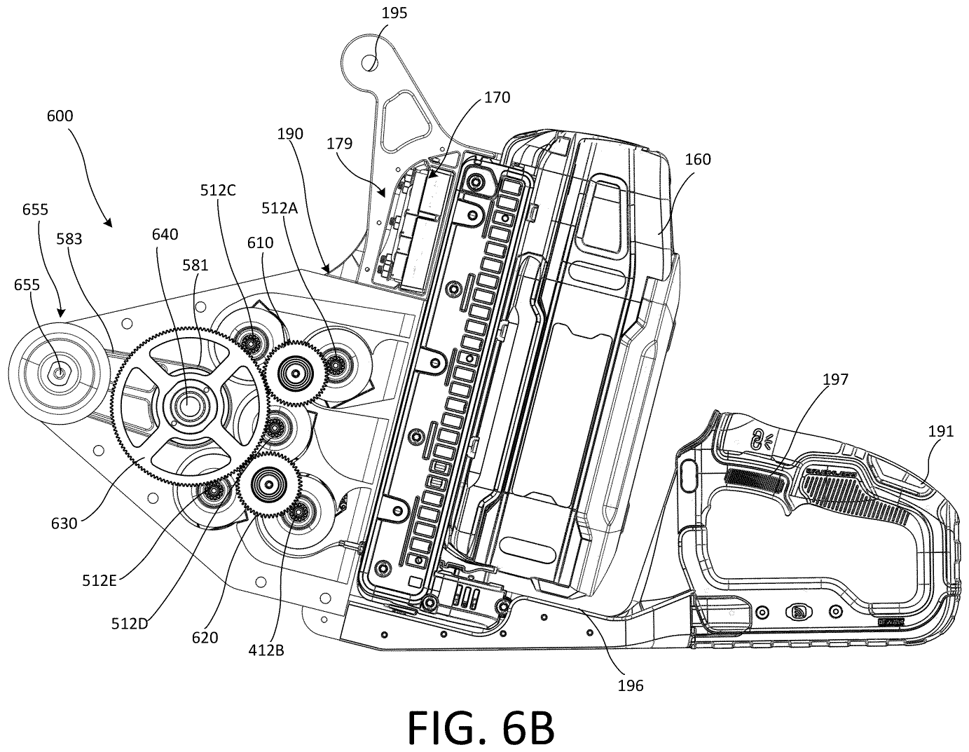

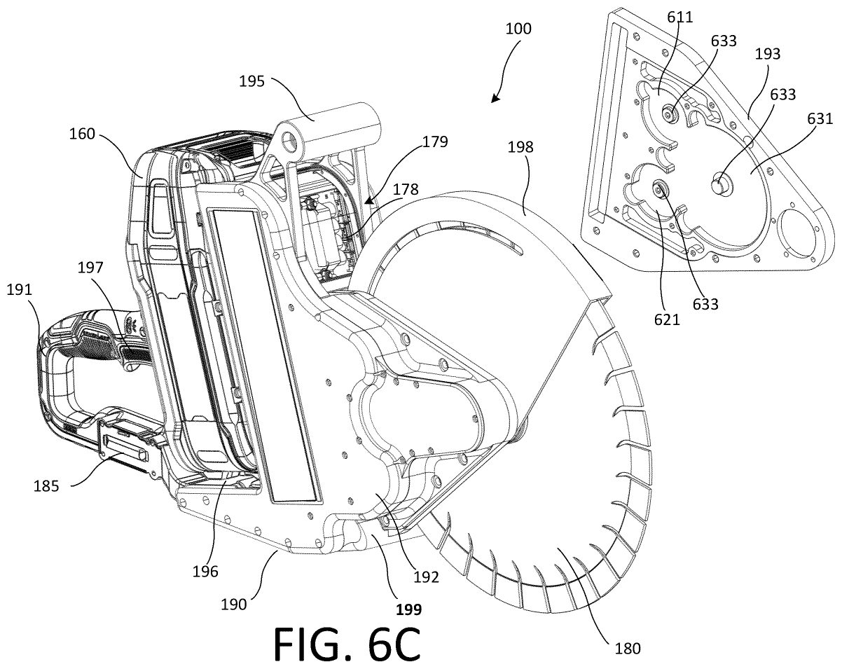

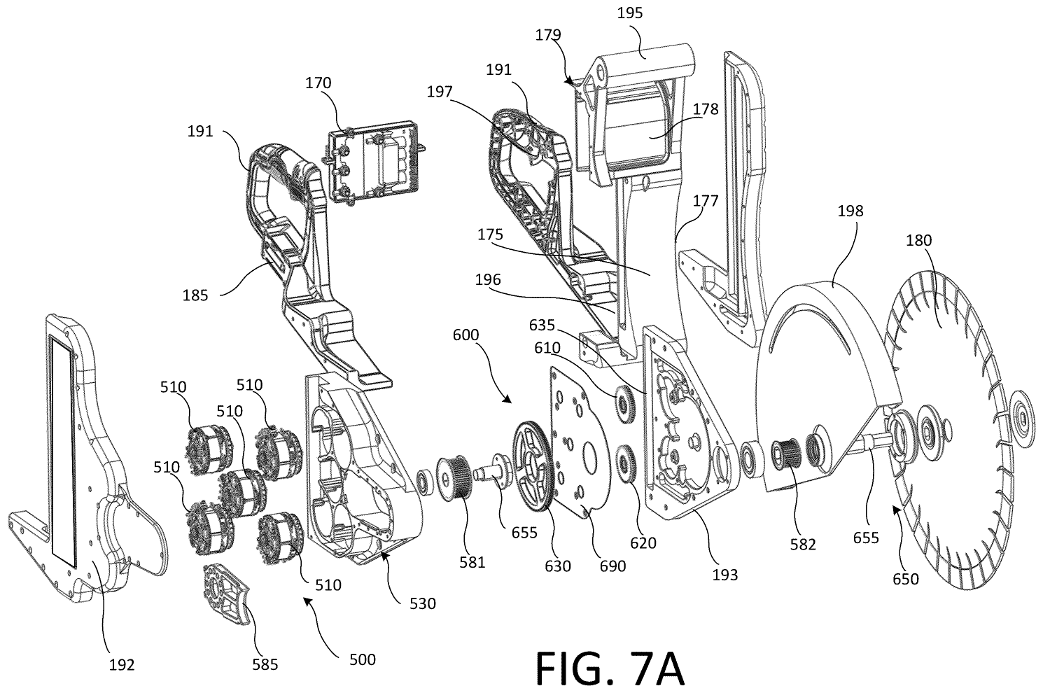

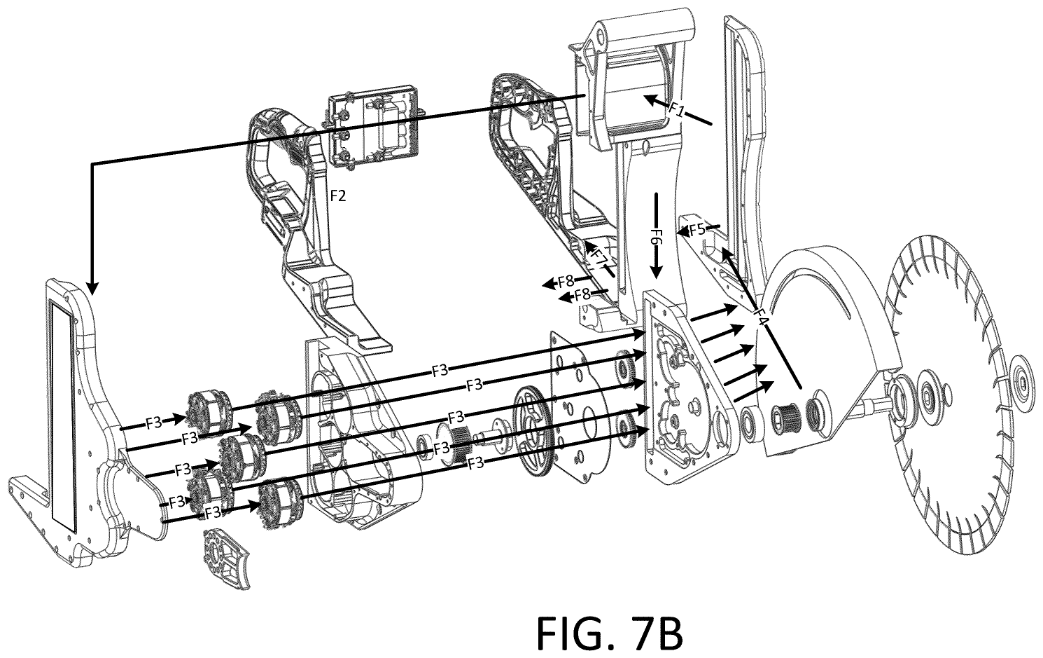

An example power-driven tool, in the form of an example concrete saw 100, which may be driven by a driving system including multi-motor drive unit and a transmission, in accordance with the principles described herein is shown in FIGS. 1-7. In particular, FIG. 1 is a perspective view, and FIG. 2 is a side view, from a first side of the example concrete saw 100. FIG. 3 is a perspective view, from a second side of the example concrete saw 100. FIG. 4 is a top view of the example concrete saw 100. FIG. 5A is perspective view, and FIG. 5B is a side view, from the first side of the example concrete saw shown in FIGS. 1-4, with a motor cover 192 removed so that components of a multi-motor drive unit 500 of the example concrete saw 100 are visible. FIG. 5C is a perspective view from the second side of the example concrete saw 100, with the motor cover 192 removed, so that an internal configuration of the motor cover 192 is visible. FIG. 6A is perspective view, and FIG. 6B is a side view, from the second side of the example concrete saw 100, with a transmission cover 193 removed so that components of a transmission 600 of the example concrete saw 100 are visible. FIG. 6C is a perspective view from the first side of the example concrete saw 100, with the transmission cover 193 removed, so that an internal configuration of the transmission cover 193 is visible. FIG. 7A is an exploded view of the example concrete saw 100 shown in FIGS. 1-6C. FIG. 7A is an exploded view, illustrating a flow of air through example concrete saw 100 shown in FIGS. 1-7A.

The example concrete saw 100 includes a tool housing 190 in which components, such as, for example, a driving system including a multi-motor drive unit 500, a pulley assembly 580, and a transmission 600, are received. A motor cover 192 extends across the multi-motor drive unit 500 and the pulley assembly 580, defining a corresponding portion of the tool housing 190. A transmission cover 193 extends across the transmission 600, defining a corresponding portion of the tool housing 190. The example concrete saw 100 includes a power source, in the form of a battery pack 160 in this example, removably coupled in a battery receptacle 196 defined by the tool housing 190. The power source, in the form of the battery pack 160, supplies power to the multi-motor drive unit 500, to drive a blade 180 coupled at a first longitudinal end portion of the tool housing 190. A first handle portion 191 and a second handle portion 195 provide for user operation of the concrete saw 100. The first handle portion 191 is at a second, lower longitudinal end portion, opposite the first longitudinal end portion of the tool housing 190 to which the blade 180 is coupled. The second handle portion 195 is provided at an upper, central portion of the tool housing 190. In some examples, a first hand of the user may grip the first handle portion 191, and a second hand of the user may grip the second handle portion 195. In some examples, a trigger 197 provided on the first handle portion 191 may be engaged, for example, manipulated by a user, to provide for operation of the concrete saw 100. In some examples, the second handle portion 195 may provide for stabilizing and guiding the concrete saw 100 during operation. In some examples, the concrete saw 100 may be used ambidextrously. For example, the first handle portion 191 may be gripped by one of a left hand or a right hand or the user, and the second handle portion 195 may be gripped by the other of the left hand or the right hand of the user, to accommodate user preferences for operation of the concrete saw 100. The blade 180 is partially received in a blade guard 198, In this example, the blade guard 198 is semi-circular in shape, to conform to the shape of the blade 180. The semi-circular shape of the blade guard 198 leaves a portion of the blade 180 exposed, for interaction with a workpiece during operation of the concrete saw 100, while functioning as a guard for the hand of the user on the second handle portion 195 during operation of the concrete saw 100. In some examples, the concrete saw 100 includes a water valve attachment portion 185. The water valve attachment portion 185 provides for attachment of a water source, to provide for cooling of the blade area and cutting or abrading area during operation of the concrete saw 100.

The multi-motor drive unit 500, the pulley assembly 580, and the transmission 600 output a rotational force, for example, in response to power supplied by the battery pack 160 that rotates a blade 180. In particular, rotary force generated by the multi-motor drive unit 500 is transmitted, via the transmission 600, to the pulley assembly 580 to drive the pulley assembly 580, which, in turn, rotates the blade 180. As shown in FIGS. 5A-5C, the multi-motor drive unit 500 includes a plurality of motors 510 that each output a rotational force, or torque. Each of the plurality of motors 510 includes a pinion 512 (now shown in FIGS. 5A-5C; see FIG. 6A) that outputs the rotational force, or torque generated by the respective motor 510 to the transmission 600.

In the example arrangement shown in FIGS. 6A-6C, three of the pinions 512 are in meshed engagement with a master gear 630, or output gear, or a driving gear, of the transmission 600, so as to transmit the rotational force, or torque, output by the respective motors 510 to the master gear 630, or output gear, or driving gear. The remaining two pinions 512 are in meshed engagement with a first idler gear 610 and a second idler gear 620 of the transmission 600, such that the rotational force, or torque, output by the respective motors 510 is transmitted to the master gear 630, or output gear, or driving gear, via the first idler gear 610 and the second idler gear 620. The rotational force, or torque, output by the master gear 630 is transmitted to the pulley assembly 580 via a driving shaft 640 on which the master gear 630, or output gear, or driving gear, is mounted.

In this example arrangement, a belt 583 extends around a first pulley 581 and a second pulley 582 of the pulley assembly 580. In this example arrangement, the first pulley 581 may be considered an input pulley, or a driving pulley, and the second pulley 582 may be considered to be an output pulley, or a driven pulley. A pulley plate 585 maintains an axial position, and a relative position of the first pulley 581 and second pulley 582, and alignment of the belt 583. The first pulley 581 is mounted on, and rotates together with the driving shaft 640 driven by the master gear 630, or output gear of the transmission 600. In some examples, the driving shaft 640 incorporates surface geometry, such as flat portions, for example in the form of a D-shaft, that preclude rotation of the master gear 630 and the first pulley 581 relative to the driving shaft 640. In some examples, the master gear 630 and the first pulley 581 may be press fit on the driving shaft 640. The second pulley 582 is driven by the belt 583 coupled on the first and second pulleys 581, 582. The second pulley 582 is mounted on an output shaft 655, with the output shaft 655 transmitting the rotational force, or torque, to the blade 180 via a hub assembly 650. In some examples, the output shaft 655 incorporates surface geometry, such as flat portions, for example in the form of a D-shaft, that preclude rotation of the master gear second pulley 582 and the hub assembly 650 relative to the output shaft 655. In some examples, the second pulley 582 and the hub assembly 650 may be press fit on the output shaft 655.

In some examples, a control module 170 may be received in a control housing 179 formed on an upper portion of the tool housing 190, proximate the second handle portion 195. The control module 170 may provide for control of the concrete saw 100 during operation. For example, control module 170 may control the flow of power from the battery pack 160 to plurality of motors 510 in response to user manipulation of the trigger 197.

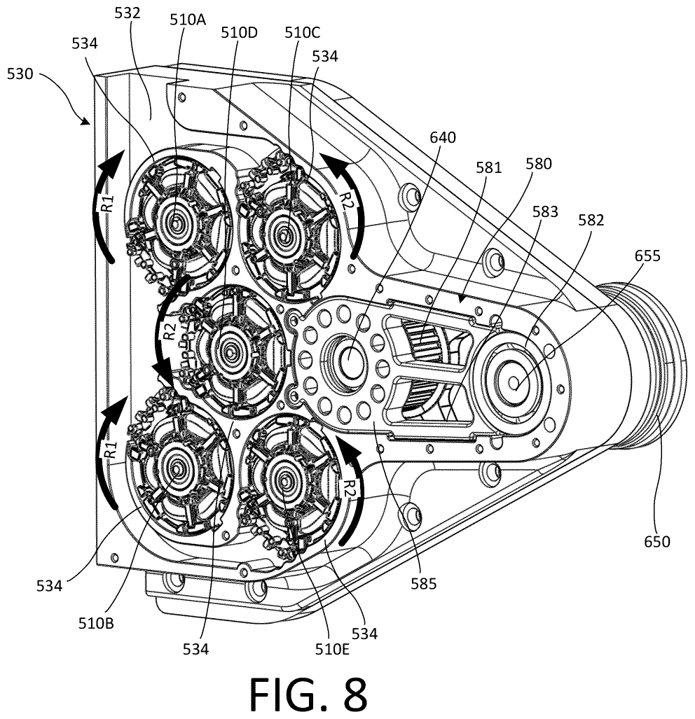

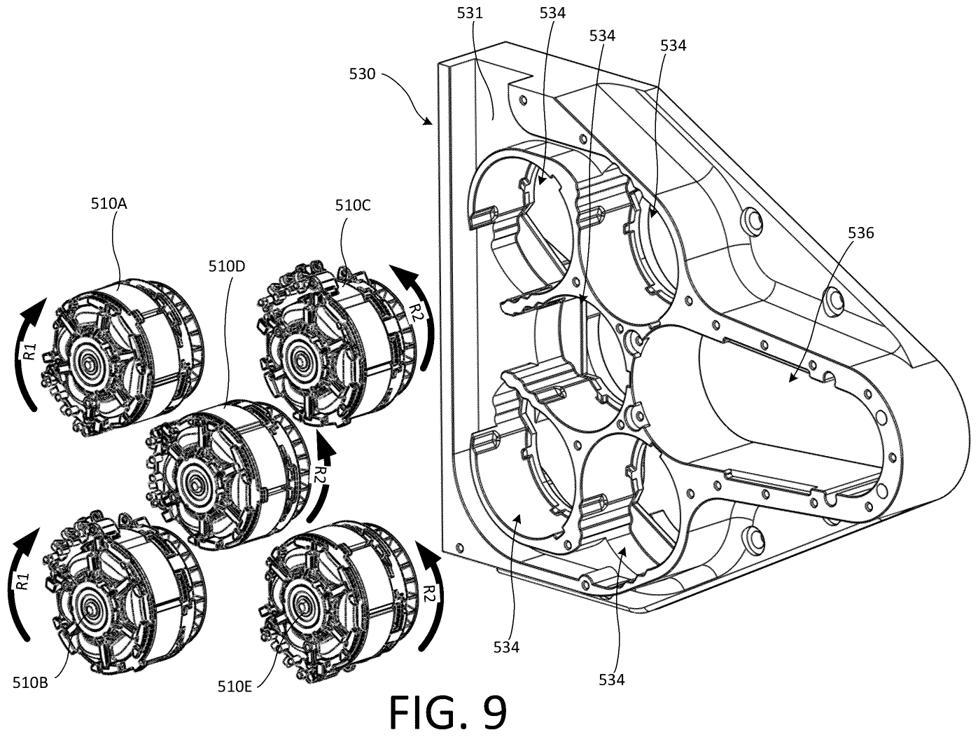

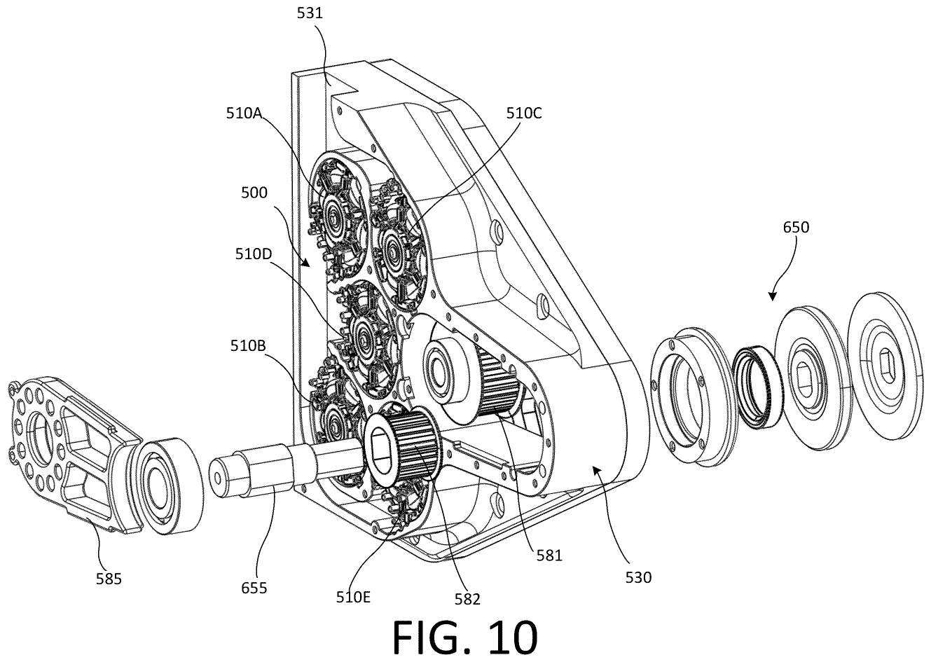

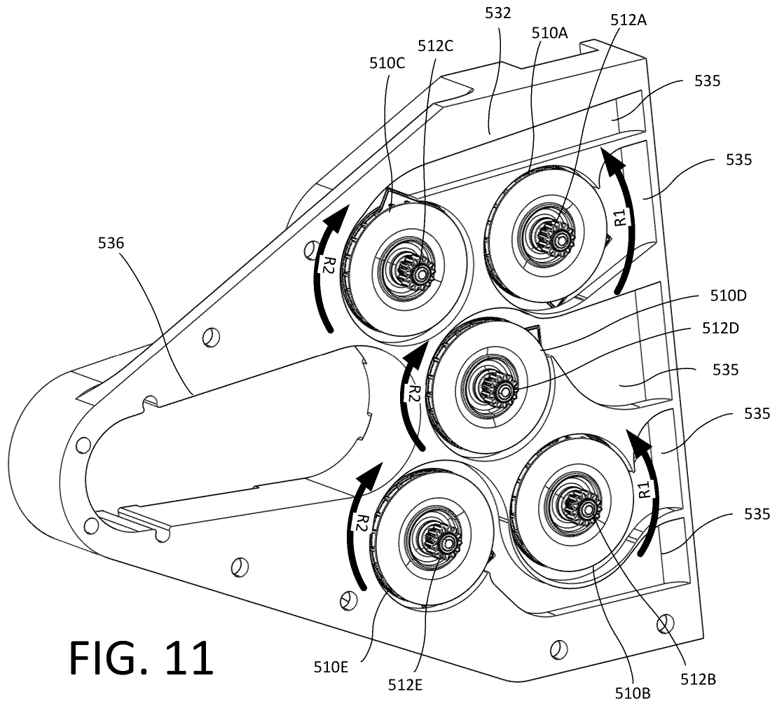

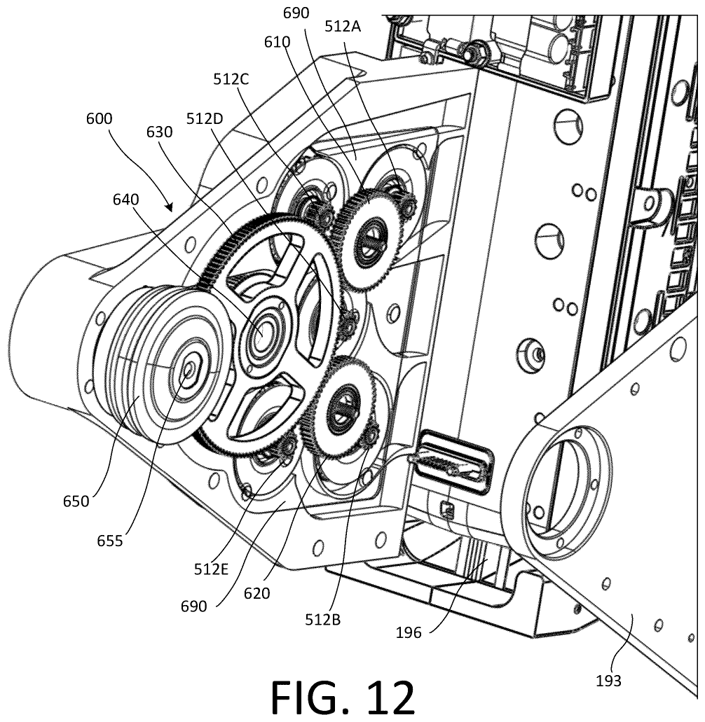

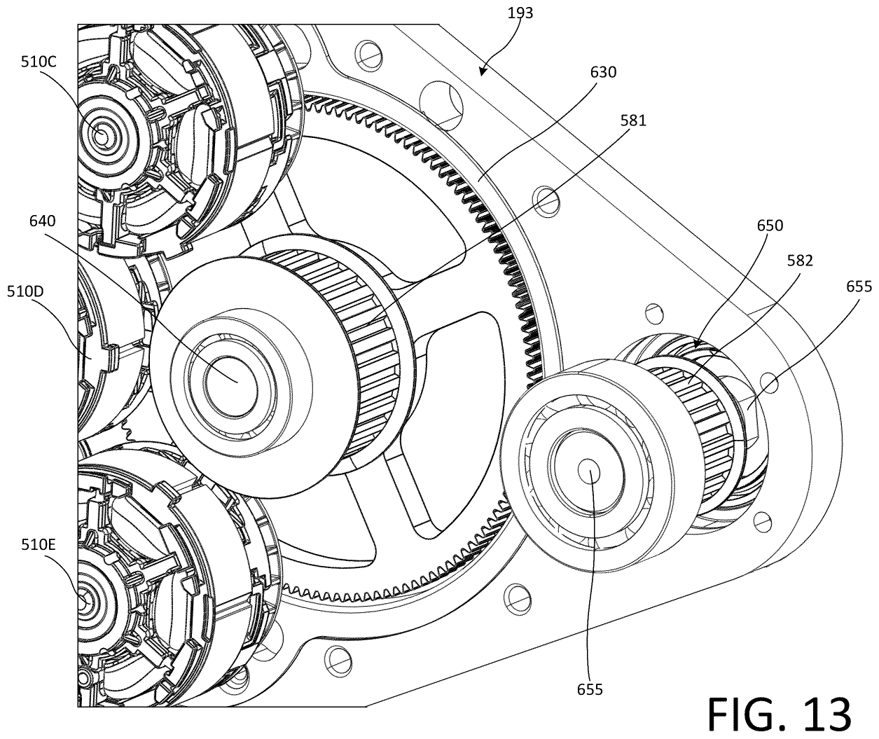

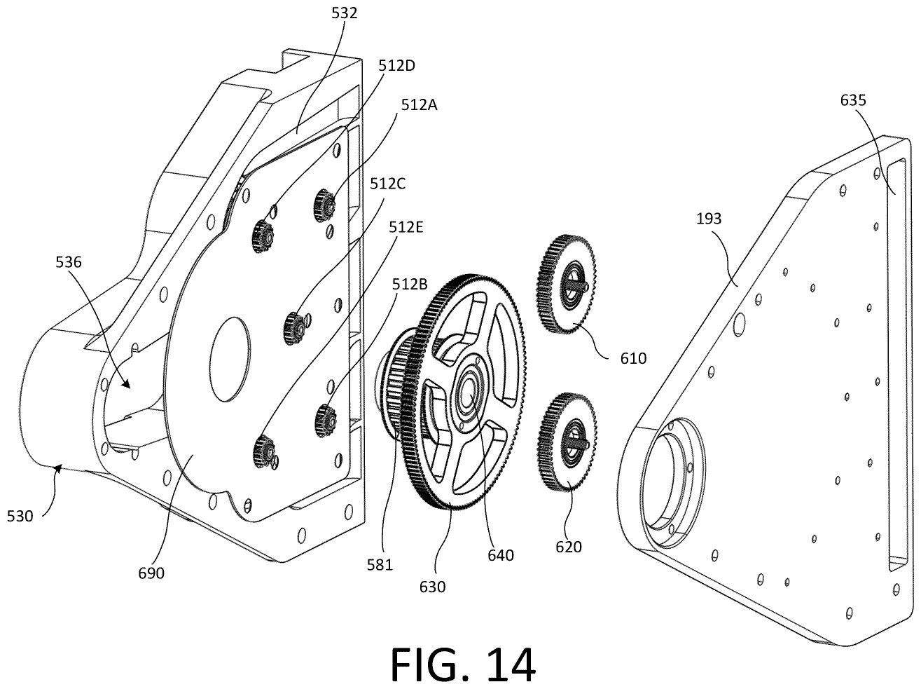

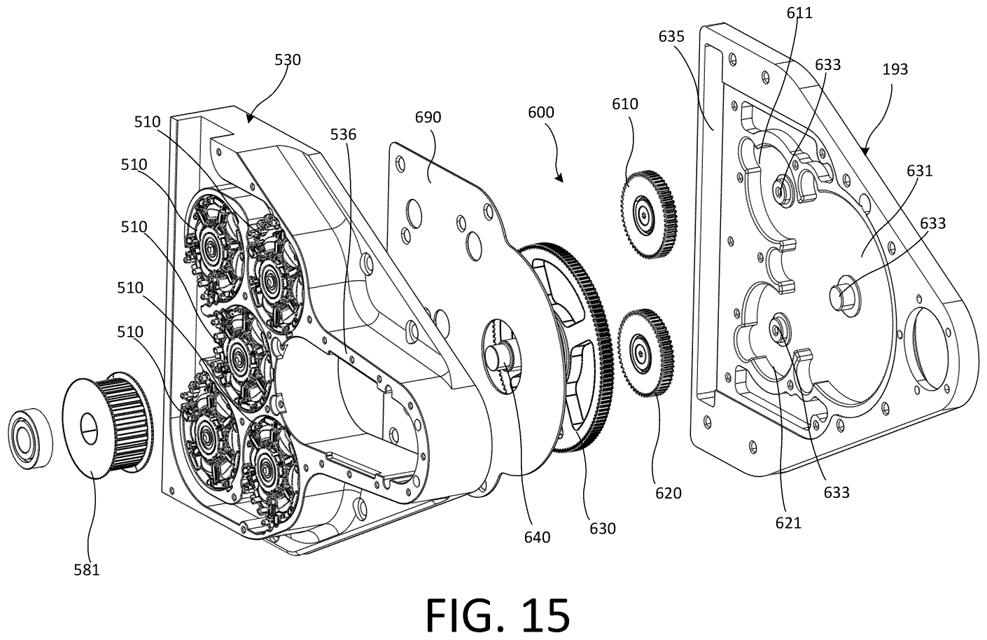

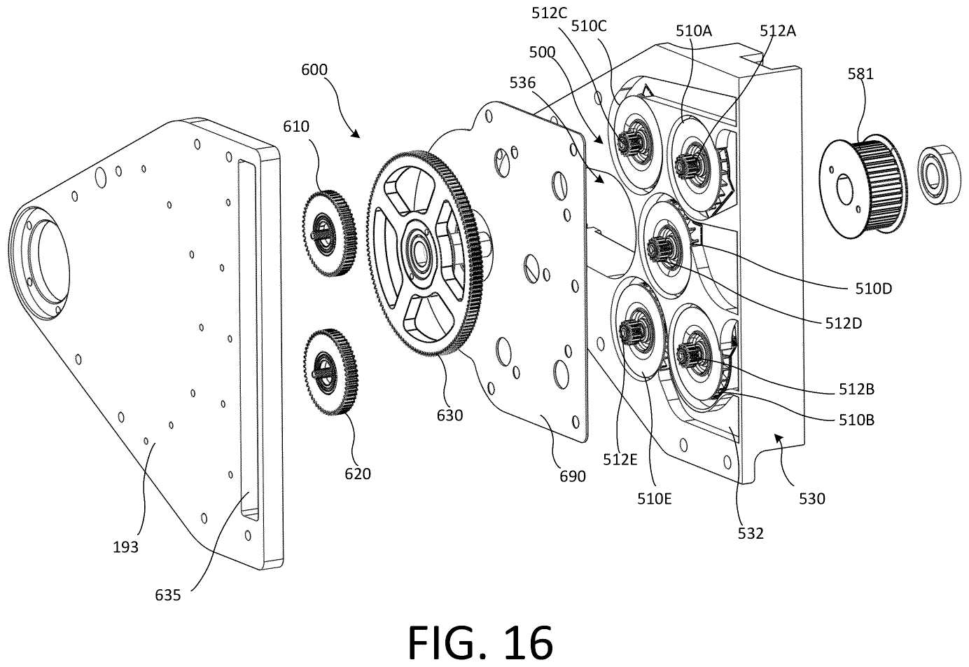

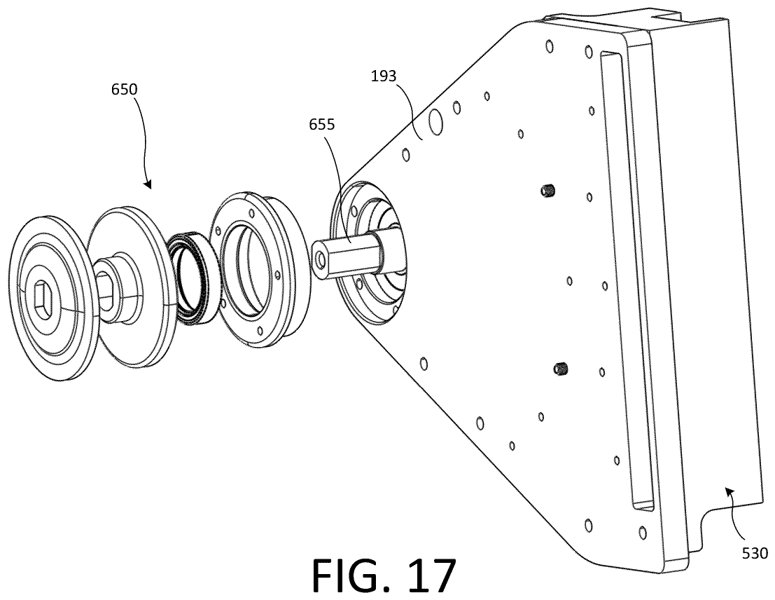

Operation of the driving system including the multi-motor drive unit 500 and the transmission 600 will be described in more detail with respect to FIGS. 8-16. FIG. 8 is a close-in assembled view from a first side of the multi-motor drive unit 500, the plurality of motors 510 and the pulley assembly 580 installed in a motor adapter 530. FIG. 9 is a partially exploded view, illustrating the plurality of motors 510 separated from the motor adapter 530. FIG. 10 is a partially exploded view of the pulley assembly 580 relative to the motor adapter 530 and the plurality of motors 510. FIG. 11 is a close-in view illustrating the plurality of motors 510 from a second side of the multi-motor drive unit 500. FIG. 12 is a close-in assembled view, illustrating components of the transmission 600 assembled on the motor adapter 530 and engaged with the plurality of motors 510. FIG. 13 is a close-in view, in which the motor adapter 530, the plate 690, the belt 583, and the pulley plate 585 are omitted, so that the relative placement of the plurality of motors 510, the master gear 630, and the first pulley 581 and second pulley 582 are visible. FIG. 14 is a partially exploded view of the transmission 600 relative to the motor adapter 530. FIG. 15 is a first partially exploded view, and FIG. 16 is a second partially exploded view, of the driving system including the multi-motor drive unit 500, the transmission 600, and the pulley assembly 580. FIG. 17 is an exploded view of the hub assembly 650.

As described above, the multi-motor drive unit 500 and the transmission 600 are housed within the tool housing 190 of the example concrete saw 100, with the motor cover 192 and the transmission cover 193 defining corresponding exterior portions of the tool housing 190. The multi-motor drive unit 500 includes the plurality of motors 510 engaged with the master gear 630 of the transmission 600 to cooperatively drive the driving shaft 640.

Each of the plurality of motors 510 may be, for example, a Brushless Direct-Current (BLDC) motor. In particular, in some examples, each of the motors 510 may be a three-phase BLDC motor having a rotor assembly rotatably received within a stator assembly. In some examples, the rotor assembly includes a rotor shaft, a rotor lamination stack mounted on and rotatably attached to the rotor shaft, and front and rear bearings arranged to support and pilot the rotor shaft. In some examples, the front and rear bearings provide radial and/or axial support for the rotor shaft to securely position the rotor assembly within the stator assembly.

In some examples, the rotor lamination stack can include a series of flat laminations attached together via, for example, an interlock mechanical, an adhesive, an overmold, and the like, that house or hold two or more permanent magnets therein. In some examples, the permanent magnets are surface mounted on the outer surface of the lamination stack or embedded therein. The permanent magnets may be, for example, a set of four permanent magnets that magnetically engage with the stator assembly during operation. Adjacent permanent magnets have opposite polarities such that the four permanent magnets have, for example, an N-S-N-S polar arrangement. In in some examples, the rotor permanent magnets may be made, fully or partially, of rare earth material to achieve maximum performance. In some examples, the permanent magnets may be made of less expensive ferrite materials. Due to construction and efficiency advantages of the multi-motor drive unit 500 described herein, the plurality of motors 510 operating together are capable of outputting total maximum power that is at least comparable to the power output of a conventional motor of a comparable size built with rare earth permanent magnets.

In some examples, the stator assembly includes a lamination stack having a center bore configured to receive the rotor assembly. In some examples, the stator lamination stack includes a plurality of stator teeth extending inwardly from the body of the lamination stack towards the center bore. The stator teeth define a plurality of slots therebetween. A plurality of stator windings are wound around the stator teeth. The stator windings may be coupled and configured in a variety of configurations, e.g., series-delta, series-wye, parallel-delta, or parallel-wye. The stator windings are electrically coupled to motor terminals mounted on the outer surface of the stator lamination stack via an insulating mount. The motor terminals may be coupled to a power switch inverter circuit on one end, and to the stator winding on the other end. The inverter circuit energizes the coil windings using a set commutation scheme. In some examples, three motor terminals are provided to electrically power the three phases of the motor 510.

In some examples, front and end insulators may be provided on the end surfaces of the stator lamination stack to insulate the lamination stack from the stator windings. The end insulators may be shaped to be received at the two ends of the stator lamination stack. In some examples, each insulator includes a radial plane that mates with the end surfaces of the stator lamination stack, with the radial plane including teeth and slots corresponding to the stator teeth and stator slots. The radial plane may also include axial walls that penetrate inside the stator slots, so that the end insulators cover and insulate the ends of the stator teeth from the stator windings. In some examples, a fan is mounted on and rotatably attached to a distal end of the rotor shaft, with the rotor shaft fixed inside the rotor lamination stack. The fan rotates with the rotor shaft to cool the motor 510, particularly the stator assembly.

In some examples, the motor 510 includes bearing support members formed as motor caps disposed at and secured to the two ends of the stator assembly. The bearing support members provide structural support for the front and rear bearings relative to the stator assembly. In some examples, one or both of the bearing support members are piloted to stator slots and/or the end insulators.

As shown in FIGS. 8-11, the multi-motor drive unit 500 includes an arrangement of five motors 510, each mounted in a corresponding opening 534 in the motor adapter 530. The motor adapter 530 includes a first side 531 defining an intake side of the multi-motor drive unit 500, and a second side 532 defining an exhaust side of the multi-motor drive unit 500. The plurality of motors 510 are at least partially axially retained in the respective openings 534 by a plurality of pads 511 formed on an interior facing side of the motor cover 192. The plurality of pads 511 are arranged so as to be positioned against, or abut, a corresponding plurality of bearing points 533 on the motor adapter 530, to maintain an axial position of the plurality of motors 510 in the corresponding opening 534. In this example arrangement, some of the motors 510, for example a first subset of the plurality of motors 510, rotate in a first direction, for example, a clockwise direction as illustrated by the arrows R1 in the orientation shown in FIGS. 8 and 9, in response to power supplied to the motors 510 from the battery pack 160. In this example arrangement, some of the motors 510, for example a second subset of the plurality of motors 510, rotate in a second direction, for example, a counterclockwise direction as illustrated by the arrows R2 in the orientation shown in FIGS. 8 and 9, in response to power supplied to the motors 510 from the battery pack 160. In this example arrangement, the first subset of the plurality of motors 510 includes a first motor 510A and a second motor 510B that rotate in the direction of the arrows R1. In this example arrangement, the second subset of the plurality of motors 510 includes a third motor 510C, a fourth motor 510D, and a fifth motor 510E that rotate in the direction of the arrows R2. Rotation of the motors 510 in this manner causes corresponding rotation of the pinions 512 of the motors 510. In particular, as shown in FIG. 11, a pinion 512A of the first motor 510A and a pinion 512B of the second motor 510B rotate in the direction of the arrows R1 (corresponding to the rotation of the first motor 510A and the second motor 510B), and a pinion 512C of the third motor 510C, a pinion 512D of the fourth motor 510D, and a pinion 512E of the fifth motor 510E rotate in the direction of the arrows R2 (corresponding to the rotation of the third motor 510C, the fourth motor 510D, and the fifth motor 510E), in response to the above described rotation of the motors 510.

As described above, the transmission 600 is coupled to the plurality of motors 510 to receive a driving force, for example, a rotational driving force, or torque, and transmit the driving force, or torque, to the blade 180 for rotation of the blade 180. As shown in FIGS. 6A and 12-15, in some examples, a plate 690 is positioned in the motor adapter 530, between the multi-motor drive unit 500 and the transmission 600. In some examples, a first recess 611 formed in the transmission cover 193 may correspond to the first idler gear 610, a second recess 621 formed I the transmission cover 193 may correspond to the second idler gear 620, and a third recess 631 formed in the transmission cover 193 may correspond to the master gear 630, such that when the transmission cover 193 is coupled to the tool housing 190, the first idler gear 610, second idler gear 620 and master gear 630 are received in, and rotate in, the corresponding recesses 611, 621, 631. In some examples, pads 633 are formed on the interior facing side of the transmission cover 193. The pads 633 may be formed at positions respectively corresponding to central portions of the first idler gear 610, second idler gear 620 and master gear 630, so as to maintain an axial position of the first idler gear 610, second idler gear 620 and master gear 630.

In this example arrangement, the transmission 600 includes the first idler gear 610 and the second idler gear 620. The first idler gear 610 and the second idler gear 620 are each rotatably mounted on a respective shaft coupled on the motor adapter 530. The first idler gear 610 is in meshed engagement with the pinion 512A of the first motor 510A, such that the first idler gear 610 rotates in response to rotation of the first motor 510A, and transfers the rotary force to the master gear 630. Similarly, the second idler gear 620 is in meshed engagement with the pinion 512B of the second motor 510B, such that the second idler gear 620 rotates in response to rotation of the second motor 510B, and transfers the rotary force to the master gear 630. The pinion 512C of the third motor 510C, the pinion 512D of the fourth motor 510D, and the pinion 512E of the fifth motor 510E are each in meshed engagement with the master gear 630, such that the master gear 630. In this arrangement, the master gear 630 rotates in response to rotation of the first motor 510A and/or the second motor 510B and/or the third motor 510C and/or the fourth motor 510D and/or the fifth motor 510E.

The master gear 630 is mounted on a driving shaft 640 that rotates together with the master gear 630. Rotation of the driving shaft 640 drives the pulley assembly 580, which, in turn, provides for rotation of the blade 180. The pulley assembly 580 is received in an opening 536 in the motor adapter 530. The pulley assembly 580 includes a first pulley 581, or a driven pulley positioned at a first end portion of the opening 536, and a second pulley 582, or a driving pulley positioned at a second end portion of the opening 536, with a belt 583 coupling the first pulley 581 and the second pulley 582. The first pulley 581 is mounted on the driving shaft 640, such that the first pulley 581 rotates together with the master gear 630 and the driving shaft 640. The second pulley 582 is mounted on an output shaft 655, such that the output shaft 655 rotates together with the second pulley 582. The belt 583 extends around an outer circumferential surface of the first pulley 581 and an outer circumferential surface of the second pulley 582, such that the belt 583 transfers a rotational force from the first pulley 581 to the second pulley 582, and the second pulley 582 rotates in response to rotation of the first pulley 581 (and the master gear 630/driving shaft 640). In some examples, a pulley plate 585 is positioned between the first pulley 581 and the second pulley 582. In some examples, the pulley plate 585 is fixed to the motor adapter 530, so that the pulley plate 585 maintains an axial position of the first pulley 581 and the second pulley 582, and maintains a relative position of the first pulley 581 and the second pulley 582. In some examples, the pulley plate 585 maintains alignment of the belt 583 on the first pulley 581 and the second pulley 582. The hub assembly 650 couples the driving shaft 640 to a hub portion of the blade 180, to transmit the rotational force, or torque, from the pulley assembly 580 to the blade 180, to provide for rotation of the blade 180. In some examples, the second pulley 582 is smaller than the first pulley 581. For example, in some implementations, a diameter of the second pulley 582 is smaller than a diameter of the first pulley 581. This may provide for an increase in rotational speed, or torque, output to the blade 180 via the output shaft 655 and the hub assembly 650, while maintaining a relatively small profile.

FIG. 13 illustrates the relative placement of the components of the multi-motor drive unit 500, the transmission 600, and the pulley assembly 580. In particular, in FIG. 13, the motor adapter 530, the plate 690, the belt 583, and the pulley plate 585 are omitted, so that the relative placement of the plurality of motors 510, the master gear 630, and the first pulley 581 and second pulley 582 are visible.

In operation, in response to an application of power to the motors 510 (for example, via user manipulation of the trigger 197), the motors 510 generate a rotary force, or torque. The rotary force, or torque, generated by the motors 510 is transmitted, by the transmission 600, to the pulley assembly 580, where the rotary force, or torque, is output to the blade 180 via the hub assembly 650, causing the blade 180 to rotate to perform an operation on a workpiece. The arrangement of the first and second handle portions 191, 195, with the control module positioned just below and to the rear of the second handle portion 195, and the battery receptacle 196 defined between the handle portions 191, 195 may help to define an air flow path through the concrete saw 100 that facilitates operation of the plurality of motors 510, while also maintaining efficient and effective cooling of the components of the concrete saw 100.

The arrangement of the first and second handle portions 191, 195, with the control module positioned just below and to the rear of the second handle portion 195, and the battery receptacle 196 defined between the handle portions 191, 195 may help to define an air flow path through the concrete saw 100 that facilitates operation of the plurality of motors 510. In some examples, cooling air is drawn into the tool housing 190 in the direction of the arrow F1 shown in FIG. 7B, through a meshed portion 178 defining an outer portion of the control housing 179, and an inlet into a cooling flow path defined through the concrete saw 100. The cooling air flows through the control housing 179 in the direction of the arrow F2, across the control module 170 to provide cooling air to the control module 170, and into the space defined between the motor cover 192 and the first side 531 of the motor adapter 530. The cooling air is then drawn through the plurality of motors 510 (due to the operation of the fans of the plurality of motors 510) in the direction of the arrows F3, and discharged from an exhaust side of the plurality of motors 510. From the discharge side of the plurality of motors 510, the cooling air turns and flows through a plurality of exhaust channels in the direction of the arrows F4. The plurality of exhaust channels may be defined by a plurality of recesses 535 formed in the second side 532 of the motor adapter 530, extending from the exhaust side of each of the plurality of motors 510, together with the plate 690. In some examples, a configuration (for example, a size and/or a shape and/or a contour and/or a volume) of each of the plurality of recesses 535 may be set to substantially equalize a flow or air through each of the plurality of motors 510. The plurality of exhaust channels, together with the transmission cover 193, may direct the cooling air in the direction of the arrows F5, through a discharge opening 635 in the transmission cover 193 (see FIG. 14) and through a discharge channel 177 into a discharge chamber 175 defined within a portion of the tool housing 190 below the control housing 179, adjacent the first side 161 of the battery pack 160 installed in the battery receptacle 196. The air may then flow through the discharge chamber 175, in the direction of the arrow F6, and turn at a base portion of the tool housing 190 and flow in the direction of the arrow F7, where it is discharged at a base portion of the tool housing 190, for example, proximate the second side 162, of the battery pack 160, in the direction of the arrows F8, through discharge ports formed in the base portion of the battery receptacle 196.

In the example cooling air flow described above with respect to FIG. 7B, cooling air is first provided to the control module 170. The cooling air intake location at the meshed portion 178 of the control housing 179 in which the control module 170 is received is at a location on the concrete saw 100 that is least likely to experience the ingress of water, debris and the like due to a cutting or abrading operation being performed by the concrete saw 100, with the blade guard 198 providing additional shielding from debris due to a cutting or abrading operation. This provides for a cleaner, less particulate laden cooling air flow into the concrete saw 100, and corresponding improved cooling to the components to be cooled. The example cooling flow provides for discharge of the air flow at a location that is furthest from the user during operation of the concrete saw 100, and in a diffused discharge pattern. In the example cooling air flow described above with respect to FIG. 7B, a positive pressure system is generated after flowing through the plurality of motors 510. This positive pressure system will inhibit ingress of water, debris and the like into the transmission 600. This positive pressure system will also inhibit ingress of water, debris and the like into the tool housing 190 through seams or other openings in the tool housing 190, and in the lower portions of the tool housing 190, particularly those proximate a cutting or abrading area, which are typically more susceptible to the ingress of water, debris and the like.

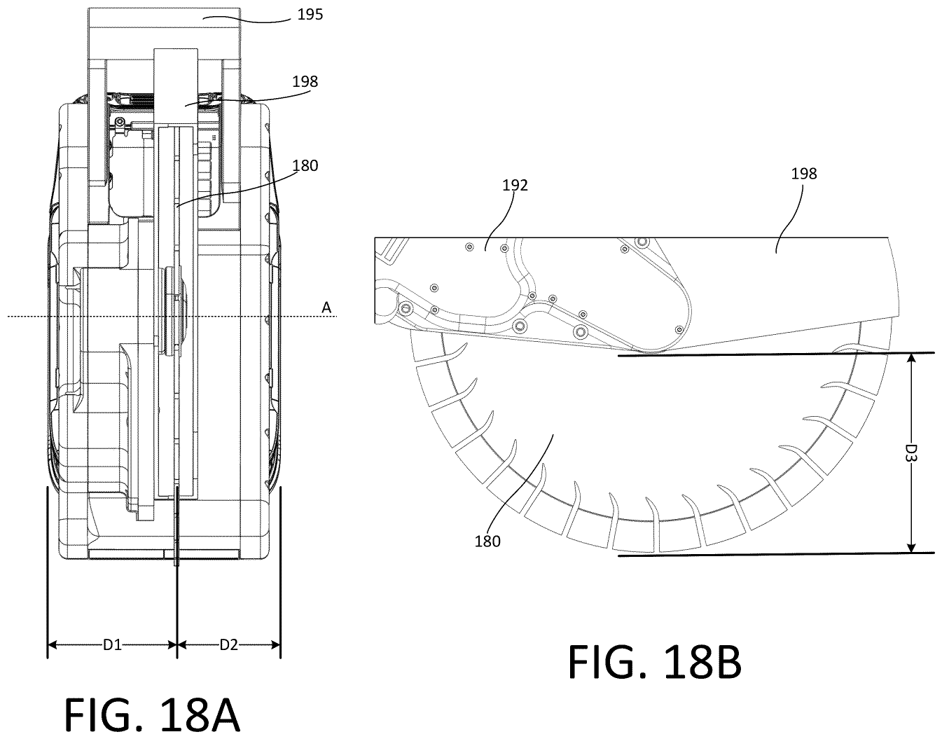

In this example arrangement, the motors 510 and the pulley assembly 580 are coupled in the motor adapter 530 in a substantially planar arrangement, with the components of the transmission 600 arranged on an opposite side of the motor adapter 530. This results in a relatively small profile associated with the driving system including the multi-motor drive unit 500/pulley assembly 580/transmission 600. This relatively narrower profile, for example, in the direction of an axis of rotation A of the blade 180, as shown in the front view of the example concrete saw 100 shown in FIG. 18A. This relatively narrower profile of the driving system may provide for a more compact overall profile of the concrete saw 100. This may improve effective lateral cut clearances of the example concrete saw 100, including, for example, clearances from walls, edges and the like of a workpiece or work area. As shown in FIG. 18A, this may result in a lateral clearance distance D1 between the first side of the concrete saw 100 a wall or other edge of a work area, and a lateral clearance distance D2 between the second side of the concrete saw 100 and a wall or other edge of a work area. In some examples, the distance D1 may be substantially the same as the distance D2. In some examples, the distance D1 may be different than the distance D2. In some examples, the distance D1 may be greater than the distance D2, to accommodate a dimension of the multi-motor drive unit 500 and the pulley assembly 580. In some examples, the distance D1 may be less than or equal to approximately 3.5 inches. In some examples, the distance D2 may be less than or equal to approximately 3.0 inches. In some examples, the distance D1 may be greater than approximately 3.5 inches. In some examples, the distance D2 may be greater than approximately 3.0 inches. In some examples, this may allow for a maximum depth of cut of the concrete saw 100, as shown in FIG. 18B. In some examples, a maximum cut depth D3 of the concrete saw 100 may be greater than or equal to approximately 5.25 inches. In some examples, the maximum cut depth D3 of the concrete saw 100 may be less than approximately 5.25 inches. This relatively compact arrangement of the driving system including the multi-motor drive unit 500, transmission 600, and the pulley assembly 580 may also facilitate ambidextrous use of the concrete saw 100.

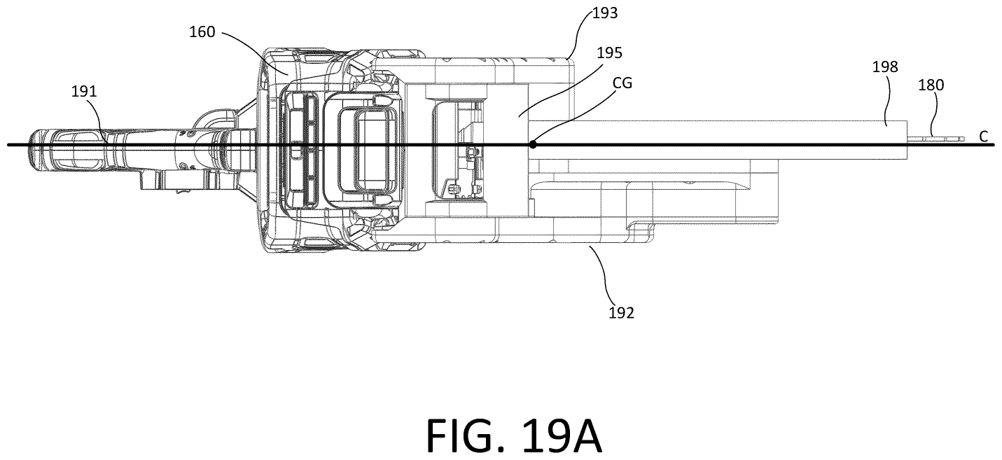

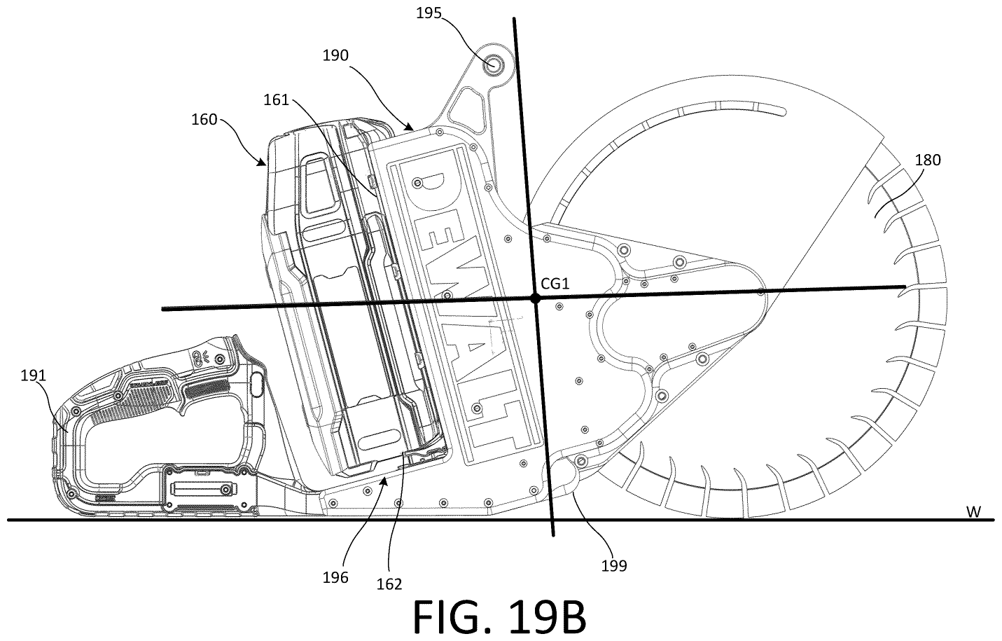

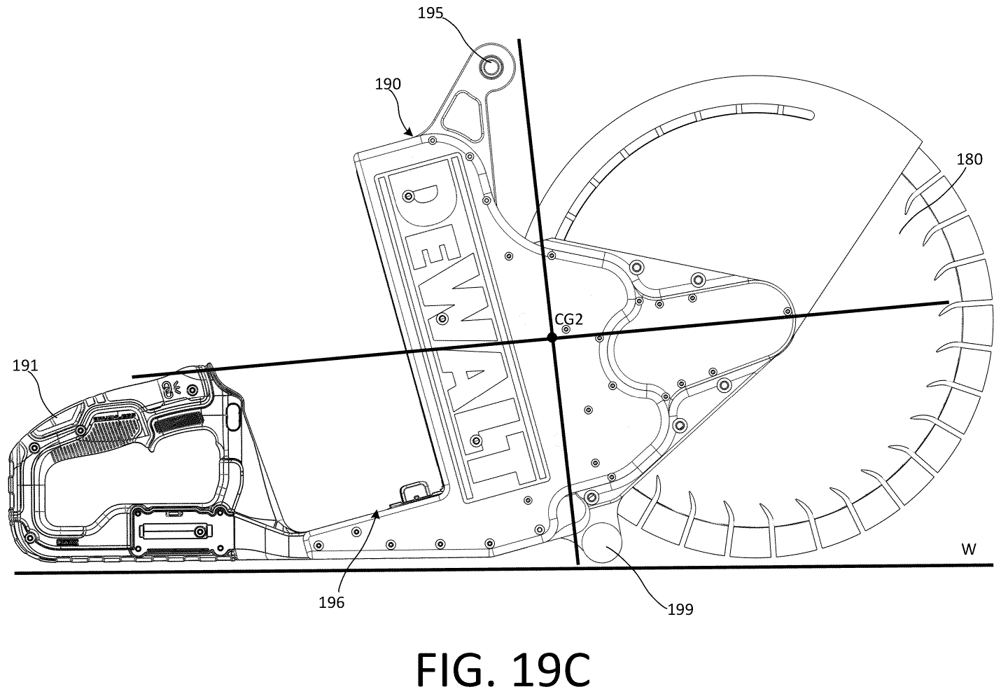

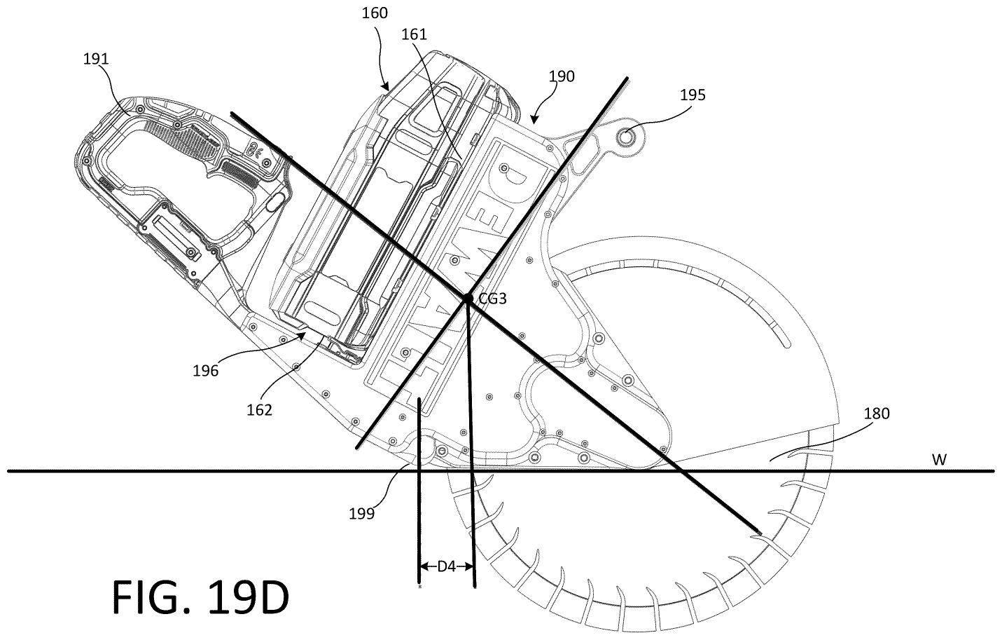

This relatively compact arrangement of the driving system including the multi-motor drive unit 500, the transmission 600, and the pulley assembly 580, and the positioning of the driving system proximate the blade 180, allow for a more forward, upright orientation of the battery pack 160 installed in the battery receptacle 196. This may contribute to the lateral alignment of a center of gravity CG of the concrete saw 100 with the first and second handle portions 191, 195 and the blade 180, thus improving stability and balance during operation of the concrete saw 100. This is illustrated in the top view of the concrete saw 100 shown in FIG. 19A. Due to the arrangement of the multi-motor drive unit 500 and pulley assembly 580 on a first side of the blade 180/first side of the concrete saw 100, and the transmission 600 on a second side of the blade 180/second side of the concrete saw 100, the center of gravity CG of the concrete saw 100 is substantially aligned with the blade 180. For example, the center of gravity CG of the concrete saw 100 and the blade 180 are aligned in a plane C, shown in FIG. 19A. This provides for laterally balanced operation of the concrete saw 100, without user intervention. With the center of gravity CG of the concrete saw 100 aligned with the plane of rotation of the blade 180, inertial forces generated during operation are generated as function of the speed of the blade 180, and are substantially contained within the plane C, further enhancing balance and stability during operation of the concrete saw 100. The first handle portion 191 and the second handle portion 195 are similarly aligned in the plane C, together with the center of gravity CG of the concrete saw 100 and the blade 180. This arrangement may facilitate ambidextrous use of the concrete saw 100, and may further enhance lateral balance and stability during operation of the concrete saw 100. In this example arrangement, the battery pack 160 is positioned between the first handle portion 191 and the second handle portion 195, between the hands of the user on the first and second handle portions 191, 195 during operation of the concrete saw 100, and in close proximity to the blade 180, further enhancing balance and stability during operation of the concrete saw 100.

FIG. 19B is a side view of the concrete saw 100 in an at rest position, with the battery pack 160 installed in the battery receptacle 196. In the at rest position shown in FIG. 19B, the center of gravity CG1 of the concrete saw 100 is positioned just forward of the second handle portion 195 in a longitudinal direction of the concrete saw 100, and below the second handle portion 195, with a flat bottom surface of the tool housing 190 resting on a work surface W, such that the blade 180 is spaced apart from the work surface W and does not contact the work surface W. This allows the concrete saw 100 with the battery pack 160 installed in the battery receptacle 196 to rest stably on the work surface W, with little to no user intervention and/or without additional cages or stands or storage devices to maintain the at rest position of the concrete saw 100.

In the arrangement and configuration shown in FIG. 19C, the battery pack 160 has been removed from the battery receptacle 196 of the concrete saw 100. This shifts the center of gravity of the concrete saw 100 from the position CG1 shown in FIG. 19B to a position CG2 shown in FIG. 19C. In this arrangement and configuration, the center of gravity CG2 is still longitudinally forward of the second handle portion 195, and below the second handle portion 195, with the flat bottom surface of the tool housing 190 resting on the work surface W, such that the blade 180 is spaced apart from the work surface W, and does not contact the work surface W. This allows the concrete saw 100 to rest stably on the work surface W, with little to no user intervention and/or ancillary supporting equipment, even with the battery pack 160 removed from the battery receptacle 196.

In the arrangement and configuration shown in FIG. 19D, the battery pack 160 is installed in the battery receptacle 196 of the concrete saw 100, and the concrete saw 100 is in an operational position. In the operational position shown in FIG. 19C, the user has lifted the concrete saw 100, for example, at the handle portions 191, 195 as the blade 180 rotates, to make cut into the work surface W. In this position, the center of gravity of the concrete saw 100 has shifted from the position CG1 shown in FIG. 19B to a position CG3 shown in FIG. 19D. In this operational position, the center of gravity CG3 remains longitudinally forward of the pivot point defined at a heel 199 on which the concrete saw 100 rests, and about which the concrete saw 100 pivots, and falls into the cut defined by the diameter of the blade 180. In the example arrangement shown in FIG. 19D, in the operational position, the center of gravity CG3 is at a distance D4, in the longitudinal direction, from the pivot point defined by the heel 199, driving a considerable portion of the weight of the concrete saw 100 into the cut being made by the blade 180 and onto the heel 199, with a notable portion of the weight of the concrete saw 100 being directed into the cut, and not borne by the user. Together with the alignment of the center of gravity CG with the blade 180 to improve lateral stability/balance during operation, enhances user operation and control of the concrete saw 100, and reduces user fatigue associated with use of the concrete saw 100.

In this example arrangement, the battery pack 160 is installed in the battery receptacle 196 of the tool housing 190 in, for example, a somewhat vertical orientation. For example, the battery pack 160 may include a first side 161 that is coupled to rails formed on the tool housing 190, to allow for connection of terminals of the battery pack 160 for conveyance of power to the concrete saw 100. A second side 162 of the battery pack 160 may be positioned on support structure, for example, biased support structures, formed in the battery receptacle 196. In this example arrangement, a dimension, for example a length of the first side 161 of the battery pack 160 may be greater than a dimension, for example a length of the second side 162 of the battery pack 160, so that the battery pack 160 is accommodated within the battery receptacle 196 defined between the first handle portion 191 and the second handle portion 195/tool housing 190/multi-motor drive unit 500. In this example arrangement, the battery receptacle 196 is defined by a u-shaped recess formed between the first handle portion 191 and the portion of the tool housing 190 housing the multi-motor drive unit 500. A considerable amount of the weight of the concrete saw 100 may be attributable to the battery pack 160. In this example arrangement, this weight is borne by the corresponding portion of the tool housing 190 supporting the first side 161 of the battery pack 160, and the support structures supporting the second side 162 of the battery pack 160, rather than the weight of the battery pack 160 hanging on the rails formed within the battery receptacle 196. This configuration of the battery receptacle 196 and the battery pack 160 received therein contributes to the positioning of the center of gravity CG of the concrete saw 100 as described above, such that a considerable amount of the weight of the concrete saw 100 is driven into the cut during operation of the concrete saw 100, rather than being borne by the user.

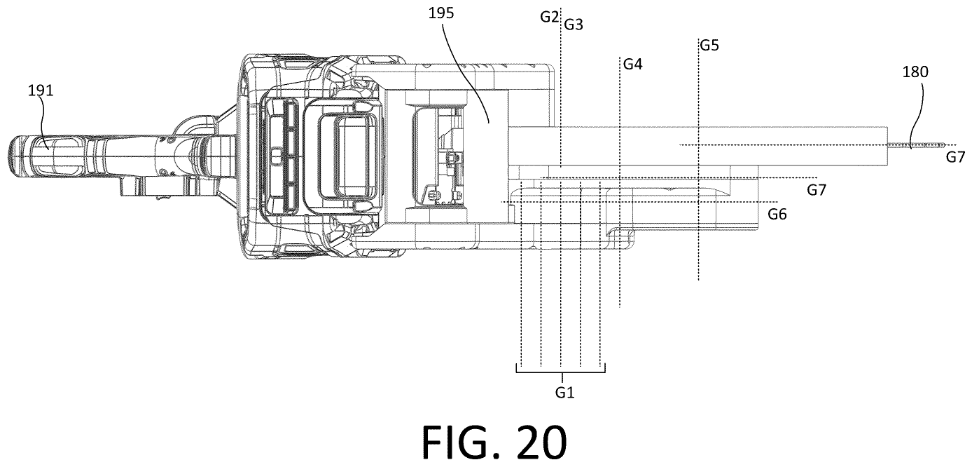

In the example arrangement of the plurality of motors 510 of the multi-motor drive unit 500 described above, all of the motors 510 are engaged with the master gear 630 of the transmission 600, with axes of rotation of the motors 510 of the multi-motor drive unit 500, the first and second idler gears 610, 620 and master gear 630 of the transmission 600, the first and second pulleys 581, 582 of the pulley assembly 580, and the blade 180 all arranged in parallel. This is illustrated in the top view of the concrete saw 100 shown in FIG. 20. In this arrangement, the axes of rotation G1 of the plurality of motors 510, the axis of rotation G2 of the first idler gear 610, the axis of rotation G3 of the second idler gear 620, the axis of rotation G4 of the master gear 630, the driving shaft 640, and the first pulley 581, and the axis of rotation G5 of the second pulley 582, the output shaft 655, and the blade 180 are all arranged substantially in parallel. The parallel axis arrangement of the motors 510, the gears 610, 620, 630, the pulleys 581, 582, and the blade 180 provide for more stable operation of the concrete saw 100, and reduce vibratory and/or inertial forces experienced by the user during operation of the concrete saw 100.

A plane of rotation G6 of the plurality of motors 510 is aligned with a plane of rotation G7 of the blade 180 and a plane of rotation G8 of the gears 610, 620, 630 of the transmission 600. Alignment of the plurality of motors 510, and rotation of the plurality of motors 510, in parallel to rotation of the blade 180, and the cut made by the blade 180 produce reaction forces that are coplanar with the blade 180, thus further reducing reaction forces experienced by the user during operation of the concrete saw 100.

As described above, in this example arrangement, some of the motors 510 (for example, the first motor 510A and the second motor 510B) rotate in a first direction R1, and some of the motors 510 (for example, the third motor 510C, the fourth motor 510D, and the fifth motor 510E) rotate in a second direction R2, opposite the first direction R1. In this arrangement, inertial forces due to operation of the first and second motors 510A, 510B cancel out inertial forces generated due to operation of all but one of the third, fourth and fifth motors 510C, 510D, 510E. This may reduce or substantially eliminate a significant amount of reaction torque associated with operation of the motors 510, thus improving balance and control of the concrete saw 100, and reducing user fatigue during operation of the concrete saw 100.

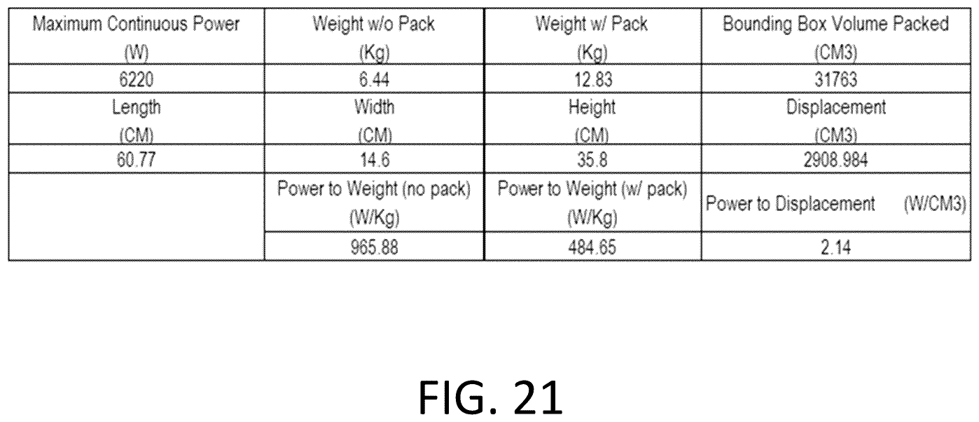

FIG. 21 is a table depicting various example power related metrics associated with one example configuration of the concrete saw 100 including a driving system incorporating the multi-motor drive unit 500, the transmission 600, and the pulley assembly 580 as described above. As shown in FIG. 21, an example configuration of the concrete saw 100 including a driving system may provide a maximum continuous output power of approximately 6220 W, for the associated volume (length, width and height) and associated weight. In this particular example configuration, the example concrete saw 100 has an overall length of approximately 60.77 cm, an overall width of approximately 14.6 cm, and an overall height of approximately 35.8 cm. This example configuration yields an overall bonding box volume of approximately 31763 cm3, and an overall displacement volume of approximately 2908 cm3. In this example configuration, the concrete saw 100 has a power to weight ratio of approximately 484.65 W/kg when equipped with the battery pack 160, or a power to weight ratio of approximately 965.88 W/kg without the battery pack 160. In some examples, a concrete saw incorporating a driving system including a multi-motor driving unit, a transmission, and a pulley assembly as described herein may have a power to volume ratio in a range of approximately 2.0 W/cm3 to approximately 2.25 W/cm3. In some examples, a concrete saw incorporating a driving system including a multi-motor driving unit, a transmission, and a pulley assembly as described herein may have a power to mass ratio in a range of approximately 920 W/kg to approximately 1000 W/kg. Depending on an overall configuration associated with a particular concrete saw, values for the power to volume ratio and/or values for the power to mass ratio may fall outside of these approximate ranges. As shown in FIG. 21, this example configuration of the concrete saw 100 provides a power displacement of approximately 2.14 W/cm3. These power metrics are representative of just one example configuration of the concrete saw 100 including the driving system incorporating the multi-motor drive unit 500, the transmission 600, and the pulley assembly 580 as described above. The power metrics presented in the table shown in FIG. 21 are provided for purposes of discussion and illustration. Similar improvements in power to weight ratios, power displacement, and other power metrics not necessarily detailed in FIG. 21 may be realized in concrete saws configured differently than the example configuration presented.

The foregoing description has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A power-driven tool, comprising:
a housing;
a driving system configured to transmit a driving force to a blade coupled to a first longitudinal end portion of the housing, the driving system including:
a multi-motor drive unit, the multi-motor drive unit including a plurality of motors;
a pulley assembly coupled to the blade; and
a transmission coupled between the multi-motor drive unit and the pulley assembly and configured to transmit a driving force generated by the multi-motor drive unit to the pulley assembly to rotate the blade,
wherein a planar arrangement of the multi-motor drive unit and the pulley assembly, and a planar arrangement of the transmission are positioned adjacent to and arranged in parallel with a central longitudinal plane defined by the blade.

2. The power-driven tool of claim 1, wherein the multi-motor drive unit includes at least one motor of the plurality of motors directly engaged with a master gear of the transmission, and at least one motor of the plurality of motors engaged with the master gear via an idler gear.

3. The power-driven tool of claim 1, wherein the multi-motor drive unit includes:
a motor adapter; and
a plurality of openings formed in the motor adapter, wherein each of the plurality of motors is received in a corresponding opening of the plurality of openings formed in the motor adapter,
wherein the pulley assembly is received in an opening of the plurality of openings formed in the motor adapter.

4. The power-driven tool of claim 3, further comprising a motor cover extending across a side portion of the motor adapter corresponding to the plurality of motors and defining a corresponding portion of the housing, wherein the motor cover includes a plurality of pads extending inward, from an interior surface of the motor cover toward the motor adapter, wherein the plurality of pads contact corresponding bearing surfaces of the motor adapter to maintain axial positions of the plurality of motors in the motor adapter.

5. The power-driven tool of claim 4, wherein the transmission is positioned at a lateral side of the motor adapter, the transmission including:
a master gear mounted on a driving shaft such that the master gear rotates together with the driving shaft;
a first idler gear engaged with the master gear; and
a second idler gear engaged with the master gear,
wherein:
a pinion of a first motor of the plurality of motors is engaged with the first idler gear,
a pinion of a second motor of the plurality of motors is engaged with the second idler gear, and
pinions of remaining motors of the plurality of motors are engaged with the master gear.

6. The power-driven tool of claim 5, further comprising a transmission cover extending across a side portion of the motor adapter corresponding to the transmission and defining a corresponding portion of the housing, wherein the transmission cover includes a plurality of recesses in which the first idler gear, the second idler gear and the master gear are received, and a plurality of pads extending inward, from an interior surface of the transmission cover toward the transmission, wherein the plurality of recesses and the plurality of pads maintain relative positions of the first idler gear, the second idler gear and the master gear.

7. The power-driven tool of claim 6, wherein the first motor and the second motor output a rotational force in a first rotational direction, and the remaining motors output a rotational force in a second rotational direction opposite the first rotational direction.

8. The power-driven tool of claim 6, wherein inertial forces generated in response to operation of the first motor and the second motor of the plurality of motors are opposite inertial forces generated in response to operation of the remaining motors of the plurality of motors, such that the inertial forces generated in response to operation of the remaining motors of the plurality of motors cancel the inertial forces generated in response to operation of the first motor and the second motor of the plurality of motors.

9. The power-driven tool of claim 6, wherein:
axes of rotation of the plurality of motors are arranged in parallel to each other;
axes of rotation of the first idler gear, the second idler gear and the master gear are arranged in parallel to each other; and
an axis of rotation of the blade is arranged in parallel to the axes of rotation of the plurality of motors and the axes of rotation of the first idler gear, the second idler gear and the master gear.

10. The power-driven tool of claim 6, wherein the pulley assembly includes:
a first pulley mounted on the driving shaft such that the first pulley rotates together with the driving shaft and the master gear;
a second pulley mounted on an output shaft such that the output shaft rotates together with the second pulley; and
a belt mounted on the first pulley and the second pulley such that the second pulley and the output shaft rotate in response to rotation of the first pulley,
wherein a hub assembly is mounted on the output shaft, and couples the blade to the output shaft such that the blade rotates in response to rotation of the second pulley and the output shaft.

11. The power-driven tool of claim 10, wherein:
axes of rotation of the first pulley, the second pulley, and the output shaft are arranged in parallel to each other, and in parallel with axes of rotation of the plurality of motors, and with axes of rotation of the first idler gear, the second idler gear and the master gear, and with an axis of rotation of the blade.

12. The power-driven tool of claim 10, wherein:
the plurality of motors of the multi-motor drive unit and the first pulley, the second pulley and the belt of the pulley assembly are arranged in a shared plane defined by the motor adapter; and
the first idler gear, the second idler gear and the master gear are arranged in a shared plane, laterally adjacent to the motor adapter, between the motor adapter and the blade.

13. The power-driven tool of claim 1, further comprising:
a battery receptacle defined at a central portion of the housing and configured to removably receive a battery therein;
a first handle portion at a second longitudinal end portion of the housing, opposite the first longitudinal end portion; and
a second handle portion at an upper central portion of the housing, longitudinally positioned between the battery receptacle and the blade.

14. The power-driven tool of claim 13, wherein the first handle portion and the second handle portion are aligned along the central longitudinal plane of the power-driven tool defined by the blade, with a center of gravity of the power-driven tool aligned along the central longitudinal plane.

15. The power-driven tool of claim 13, wherein the multi-motor drive unit is positioned between the second handle portion and the blade, and the battery received in the battery receptacle is positioned adjacent to the multi-motor drive unit, below the second handle portion.

16. The power-driven tool of claim 15, wherein, in an at rest position of the power-driven tool in which the battery is received in the battery receptacle, a center of gravity of the power-driven tool is positioned longitudinally forward of the second handle portion, and below the second handle portion, with a bottom surface of the housing positioned resting on a work surface with the blade spaced apart from the work surface.

17. The power-driven tool of claim 16, wherein, in an at rest position of the power-driven tool in which the battery is not received in the battery receptacle, a center of gravity of the power-driven tool is positioned longitudinally forward of the second handle portion, and below the second handle portion, with a bottom surface of the housing positioned resting on a work surface with the blade spaced apart from the work surface.

18. The power-driven tool of claim 15, wherein, in an operational position of the power-driven tool, in which the power-driven tool is rotated about a heel portion of the housing supported on a work surface, a center of gravity of the power-driven tool is positioned longitudinally forward of the heel portion and is aligned with a cut into the work surface defined by a diameter of the blade.

19. The power-driven tool of claim 13, further comprising a cooling flow path extending through the power-driven tool, wherein cooling air is drawn into the housing through an inlet at an upper central portion of the housing at an upper end portion of the battery receptacle proximate the first handle portion, through the plurality of motors of the multi-motor drive unit, into a discharge chamber in the housing adjacent to a side portion of the battery receptacle, and is discharged through at least one discharge port at a base portion of the battery receptacle.

20. The power-driven tool of claim 19, wherein cooling air is drawn from the inlet into a chamber defined between the housing and a first side of a motor adapter in which the plurality of motors are received, and through the plurality of motors and the motor adapter in response to operation of the plurality of motors, and is discharged from the motor adapter to the discharge chamber through a plurality of discharge channels defined in a second side of the motor adapter and respectively extending from the plurality of motors towards the discharge chamber.

21. The power-driven tool of claim 1, wherein a power to volume ratio is in a range of approximately 2.0 W/cm³ to approximately 2.25 W/cm³.

22. The power-driven tool of claim 1, wherein a power to mass ratio is in a range of approximately 920 W/kg to approximately 1000 W/kg.
